(19) United States
(12) Patent Application Publication
(10) Pub. No.: US 2026/0132673 A1
(43) Pub. Date: May 14, 2026

(54) METHOD FOR ENHANCING THE PHYSICAL PROPERTIES OF OBJECTS OR DEVICES

(71) Applicant: Raptor Sports Pty Ltd, Gilston QLD (AU)

(72) Inventor: Craig Leach, Gilston QLD (AU)

(21) Appl. No.: 19/410,795

(22) Filed: Dec. 5, 2025

Related U.S. Application Data
(63) Continuation-in-part of application No. PCT/AU2024/050587, filed on Jun. 5, 2024.

(30) Foreign Application Priority Data
Jun. 6, 2023 (AU) 2023901785
Oct. 10, 2023 (AU) 2023903247

(51) Int. Cl. E06B 9/17; B32B 27/08; B32B 27/20; E06B 9/68

(52) U.S. Cl. CPC E06B 9/17; B32B 27/08; B32B 27/20; E06B 9/68; B32B 2264/107; B32B 2307/3065; B32B 2419/00; E06B 2009/6818

(57) ABSTRACT

A protection device comprising one or more panel members moveable between a storage condition and a use condition, the one or more panels members being configured to substantially overlie a window, solar panel or door in the use condition, and wherein the one or more panel members comprise one or more layers of fire-resistant material, and wherein at least one of the one or more layers of fire-resistant material comprises a plurality of boron nitride structures, the boron nitride structures one or more forms of crystalline boron nitride structures.

### CROSS-REFERENCE TO RELATED APPLICATION

This application is a bypass continuation-in-part of International Application No.: PCT/AU 2024/050587 filed on Jun. 5, 2024, which claims the benefit of Australian Patent Application No.: AU 2023901785, filed Jun. 6, 2023 and Australian Patent Application No.: AU 2023903247 filed Oct. 10, 2023, the entire contents of which are incorporated by reference in their entireties.

### TECHNICAL FIELD

The present invention relates to a method of enhancing the physical properties of objects or devices. In particular, the present invention relates to enhancing physical properties such as the strength and hydrophobicity of objects or devices.

### BACKGROUND

Extreme weather events (such as bushfires and storms) are already a threat to people and property in many parts of the world. However, with changing climates, it is anticipated that there will be an increase in both the number and intensity of extreme weather events in the future.

During extreme weather events, windows and doors are often a point of weakness in preventing damage to buildings (and injury or death to the people inside). This is because windows and doors may be broken by flying debris or by the heat of a fire, thereby providing a point of entry into the building for water or fire.

Prior to weather events, windows and doors may be boarded up with panels of wood or the like. While potentially effective, the boarding up of windows and doors requires a person to have considerable forewarning of the weather event. In addition, manually boarding up windows and doors is labour intensive and time-consuming, taking time away from other home defence activities or evacuation preparations. Further, the boarding up of windows and doors does not comply with many building codes and standards.

Thus, there would be an advantage if it were possible to provide a protection device that were relatively quick and easy to deploy, and which provided improved protection from extreme weather events.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a protection device which may at least partially overcome at least one of the abovementioned disadvantages or provide the consumer with a useful or commercial choice.

With the foregoing in view, the present invention resides broadly, in a first aspect, in a protection device comprising one or more panel members moveable between a storage condition and a use condition, the one or more panels members being configured to substantially overlie a window, a building surface, solar panel or door in the use condition, and wherein the one or more panel members comprise one or more layers of fire-resistant material, and wherein at least one of the one or more layers of fire-resistant material comprises a plurality of boron nitride structures, the boron nitride structures comprising one or more forms of crystalline boron nitride structures.

In some embodiments of the invention, the one or more layers of fire-resistant material comprising a plurality of boron nitride structures may be a semi-permeable mesh, a lattice or a film that provides air flow in forceful weather conditions. In some embodiments of the invention, such as where the fire-resistant panel overlies a solar panel, the one or more layers may be relatively clear, or at least may permit the passage of UV radiation therethrough. In this way, little or no UV radiation is precluded from reaching the solar panel by the fire-resistant material.

The term “crystalline boron nitride structures” as used herein is intended to refer to non-amorphous forms of boron nitride. More specifically, the term is intended to refer to crystalline structures that consist of a single layer or multiple layers of boron nitride. The term “crystalline boron nitride structures” as used herein and, unless otherwise qualified, is intended to encompass forms of crystalline boron nitride such as boron nitride nanotubes, boron nitride ribbon, boron nitride wire, boron nitride sheets, boron nitride nanosheets, boron nitride nano wire, boron nitride nano ribbon, or any combination thereof. The crystalline boron nitride structures may comprise a single crystalline form of boron nitride. Alternatively, the crystalline boron nitride structures may comprise two or more forms of crystalline boron nitride.

Preferably, when two or more forms of crystalline boron nitride structures are present, the two or more crystalline forms may comprise a combination of boron nitride nanotubes, boron nitride wire, boron nitride ribbon and/or boron nitride nanosheets. The various crystalline boron nitride structures may be present in any suitable concentration. For instance, equal amounts (by weight or by volume) of each of the boron nitride structures may be provided. Alternatively, each form of boron nitride structure may comprise between 0.1% and 99.9% (by weight or by volume) of the total quantity of crystalline boron nitride structures.

In some embodiments of the invention, the two or more forms of crystalline boron nitride structures may comprise boron nitride nanotubes and boron nitride wire, or boron nitride nanotubes and boron nitride ribbon, or boron nitride nanotubes and boron nitride nanosheets, or boron nitride wire and boron nitride ribbon, or boron nitride wire and boron nitride nanosheets, or boron nitride ribbon and boron nitride nanosheets. In some embodiments of the invention, the crystalline boron nitride structures may comprise any combination of three of boron nitride nanotubes, boron nitride wire, boron nitride ribbon and/or boron nitride nanosheets. In some embodiments, the crystalline boron nitride structures may comprise all four of boron nitride nanotubes, boron nitride wire, boron nitride ribbon and/or boron nitride nanosheets.

Although the panel members will be described largely in terms of their fire-resistant properties, it is worth noting that the boron nitride structures will also impart improved mechanical properties (such as strength, impact resistance and the like) to the panel members. Thus, it will be understood that the presence of boron nitride structures will impart not just improved fire-resistant properties to the panel members, but also improved resistance to damage from impact by objects and debris. For instance, it is envisaged that the panel members may be provided with improved resistance to damage from impact by objects and debris that may occur during high wind events (storms, cyclones or the like).

The one or more panel members may be of any suitable form, and of any suitable number. For instance, in some embodiments of the invention, a single panel member may be provided. In this embodiment of the invention, the single panel member may overlie substantially the entire window, building surface, solar panel or door in the use condition. In other embodiments of the invention, a plurality of panel members may be provided. In this embodiment, each of the plurality of panel members may be configured to overlie a portion of the window or door in the use condition. However, it is envisaged that the plurality of panel members may, together, substantially overlie the entire window, surface, wall or door in the use condition.

At least some of the panel members may be connected to one another, such that movement of the protection device between the storage condition and the use condition results in simultaneous movement of two or more panel members. In other embodiments, the panel members may be positioned apart from one another in the storage condition, and may be located in abutment with (or may be joined to) one another in the use condition.

The one or more panel members may be configured to move between the storage condition and the use condition using any suitable technique. For instance, the panel members may slide or pivot relative to the window, building surface, solar panel or door between the storage condition and the use condition. Thus, in this embodiment of the invention, the one or more panel members may be in the form of shutters. In these embodiments of the invention, the one or more panels members may be substantially rigid.

In other embodiments of the invention, the one or more panel members may be at least partially wound about a reel in the storage condition, and may be unwound from the reel to overlie the window, solar panel or door in the use condition. In this embodiment, the one or more panel members may be non-rigid or flexible.

In these embodiments of the invention, it is envisaged that the one or more panels may be located in relatively close proximity to the window, building surface, solar panel or door in the storage condition. The one or more panels may then be moved from the storage condition to the use condition quickly as the need arises. The panel members may be moved between the storage condition and the use condition manually, or automatically. For instance, the protection device may further comprise an actuator, such as a motor, ram or the like, configured to move the one or more panel members between the storage condition and the use condition.

Actuation of the actuator may be controlled by a user. For instance, a user may be required to actuate the actuator manually (such as by flicking a switch or lever, pressing a button and so on) to actuate movement of the one or more panels between the storage condition and the use condition. In other embodiments of the invention, the actuator may be configured to move the one or more panels between the storage condition and the use condition automatically in response to one or more environmental parameters.

The one or more environmental parameters may be of any suitable form, and may include temperature (or a change in temperature), barometric pressure (or a change in barometric pressure), windspeed (or a change in windspeed), air quality (or a change in air quality) or the like, or any suitable combination thereof.

In these embodiments, it is envisaged that the one or more environmental parameters may indicate the presence of bushfires, or at least the right environmental conditions for bushfires to occur.

In some embodiments of the invention, the protection device may comprise one or more sensors configured to measure the one or more environmental parameters. Thus, the one or more sensors may comprise temperature sensors, barometers, anemometers, air quality monitors or the like, or any suitable combination thereof. The one or more sensors may be located adjacent or in close proximity to the one or more panel members, or may be located remote to the one or more panel members (for instance, in a location in which the environmental parameter may be more accurately measured, or which is a sufficient distance from a structure where the window, solar panel or door is located to provide time for the one or more panel members to move from the storage condition to the use condition before the extreme weather event reaches the structure.

The one or more sensors may be associated with a computing device configured to receive measurements of the environmental parameters measured by the one or more sensors. The computing device may be of any suitable form, although in a preferred embodiment of the invention, the computing device may be configured to determine whether the environmental parameters (or a change in the environmental parameters) meet or exceed a predetermined value at which the one or more panel members are moved from the storage condition to the use condition.

It is envisaged that, when the predetermined value of the environmental parameters is met or exceeded, the computing device may communicate with the actuator. The actuator may then be actuated to move the one or more panel members from the storage condition to the use condition.

Similarly, when the extreme weather event is over and the one or more sensors detect that the environmental parameters (or a change in the environmental parameters) are not met or exceeded, the actuator may be actuated to move the one or more panel members from the use condition to the storage condition.

In some embodiments of the invention, the one or more panel members may be removed from the vicinity of the window, building surface, solar panel or door and stored remotely to the window, solar panel or door when not in use.

The protection device may comprise one or more guide members associated with the panel members, the one or more guide members configured to facilitate movement of the one or more panel members between the storage condition and the use condition. The one or more guide members may comprise tracks, rails, channels or the like. In some embodiments of the invention, the one or more guide members may be configured to receive a portion of the one or more panel members.

As previously stated, the one or more panels comprise one or more layers of fire-resistant material. In some embodiments of the invention, the one or more panels may comprise a single layer, the single layer being fabricated from a fire-resistant material. In other embodiments of the invention, the one or more panel members may comprise a plurality of layers, and at least one of the plurality of layers may be fabricated from fire-resistant material.

The layers may be entirely fabricated from a fire-resistant material, or may be partially fabricated from a fire-resistant material. In a preferred embodiment of the invention, an outermost layer of the one or more panel members (i.e., a layer located furthest from the window, solar panel or door the one or more panel members overlie) may be fabricated from the fire-resistant material. In some embodiments, the layer of fire-resistant material may comprise a surface coating layer on an external surface of the one or more panel members.

In some embodiments of the invention, one or more layers of the panel members may be fabricated from conventional materials, such as wood (including plywood, particle board and the like), a fibrous cement (known colloquially as “fibro”), a polymeric material, metal or the like. In these embodiments, one or more layers of fire-resistant material may be placed on the conventional layers. Alternatively, the one or more panel members may be fabricated from one or more layers of fire-resistant material only.

In some embodiments of the invention, at least one of the one or more layers may be fabricated from a metallic material. Preferably, the metallic material may comprise a heat reflective material, such as, but not limited to, gold, silver, aluminium or copper, or any suitable combination thereof. The metallic material may be provided in the form of a metallic foil or the like.

In embodiments of the invention in which the one or more panel members comprise a plurality of layers, it is envisaged that the plurality of layers may be joined or bonded together. This may be achieved using any suitable technique, such as, but not limited to, adhesives, laminating, the use of mechanical fasteners and the like, or any suitable combination thereof.

In embodiments of the invention the one or more layers of the panel members may be fabricated to be semi-permeable to air flow, comprising of a mesh, lattice, or clear film.

In some embodiments of the invention the panel members may be fabricated from one or more layers of polymeric material. Any suitable polymeric material may be used, such as polyethylene, polypropylene, polystyrene, polyvinyl chloride, polyether sulphones, acrylonitrile butadiene styrene, polyether polyols, polyester polyols, polyacetal or polyoxymethylene (acetal, POM), polycarbonates, elastomers, thermoplastic elastomers, thermoplastic polyester, thermoplastic polyurethane, polyketones (such as but not limited to polyaryletherketone (PAEK), polyetheretherketone (PEEK), polyetherketoneketone (PEKK) or the like), acrylate polymers, poly(methyl methacrylate) (PMMA), polyphenylene sulfide (PPS), polyamides, polyphthalamide (PPA, performance Nylon), fluoropolymers (such as, but not limited to, polytetrafluoroethylene (PTFE), fluorinated ethylene propylene (FEP), polyvinylidene fluoride or polyvinylidene difluoride (PVDF), polychlorotrifluoroethylene (PCTFE), perfluoroalkoxy alkane (PFA), or the like), high density polyethylene (HDPE), ultra-high molecular weight polyethylene (UHMWPE), epoxy resins, phenolic resins or any suitable combination thereof. In this embodiment, it is envisaged that the polymeric materials may be at least semi-transparent, such that, when the fire protection device is in the use condition, a person inside a structure may be able to see through the panel members to assess the current situation.

As previously stated, at least one of the one or more layers of fire-resistant material comprises a plurality of boron nitride structures, the boron nitride structures comprising one or more forms of crystalline boron nitride structures.

In some embodiments of the invention, the layer of fire-resistant material comprising a plurality of boron nitride structures may comprise a surface coating material. In some embodiments of the invention, the surface coating material may comprise a paint, varnish or the like. The paint may be applied to an outer surface of the one or more panel members using techniques including spray (air atomized, airless, electrostatic, high volume-low pressure) brushing, and dipping. The paint may include one or more further components. In these embodiments, the one or more further components may comprise polymers (such as, but not limited to, nitrocellulose, tosylamide-formaldehyde resin or acrylate copolymer), plasticisers (such as, but not limited to diethylphthalate, dibutylphthalate or camphor), pigments (such as, but not limited to chromium oxide greens, chromium hydroxide, ferric ferrocyanide, stannic oxide, titanium dioxide, iron oxide, carmine, ultramarine, manganese violet, mica, bismuth oxychloride, natural pearls or aluminum powder), thickeners (such as, but not limited to, stearalkonium hectorite) and/or UV-stabilisers (such as, but not limited to, benzophenone-1).

In some embodiments of the invention, the surface coating material may comprise an intumescent paint. It is envisaged that the intumescent paint may be applied to the outer surface of a building. However, the intumescent paint may also be applied to interior surfaces (such as walls, ceilings, floors and the like) of the building. This may be useful in reducing the severity of housefires, such as those caused by electrical faults, appliances, fireplaces and the like.

The surface coating material may comprise any suitable weight percent boron nitride structures. For instance, the surface coating material may comprise between about 0.05 wt % and about 60 wt % boron nitride structures. More preferably, the surface coating material may comprise between about 0.1 wt % and about 55 wt % boron nitride structures. Still more preferably, the surface coating material may comprise between about 0.5 wt % and about 50 wt % boron nitride structures. Yet more preferably, the surface coating material may comprise between about 0.5 wt % and about 30 wt % boron nitride structures. Even more preferably, the surface coating material may comprise between about 0.5 wt % and about 20 wt % boron nitride structures. Still more preferably the surface coating material may comprise between about 0.5 wt % and about 10 wt % boron nitride structures.

Preferably, the surface coating material comprises a settable, curable or hardenable material. In a preferred embodiment of the invention, the boron nitride structures may be substantially homogenously distributed in the surface coating material once set or hardened.

In other embodiments of the invention, at least one layer of fire-resistant material comprising a plurality of boron nitride structures may be in the form of a composite material. In this embodiment of the invention, at least one layer of fire-resistant material may comprise a matrix material impregnated with a plurality of boron nitride structures. The matrix material may be of any suitable form, and may comprise a polymer, a metal and/or a ceramic matrix material.

Any suitable polymer may be used. For instance, the polymer may be polyethylene, polypropylene, polystyrene, polyvinyl chloride, polyether sulphones, acrylonitrile butadiene styrene, polyether polyols, polyester polyols, polyacetal or polyoxymethylene (acetal, POM), polycarbonates, elastomers, thermoplastic elastomers, thermoplastic polyester, thermoplastic polyurethane, polyketones (such as but not limited to polyaryletherketone (PAEK), polyetheretherketone (PEEK), polyetherketoneketone (PEKK) or the like), acrylate polymers, poly(methyl methacrylate) (PMMA), polyphenylene sulfide (PPS), polyamides, polyphthalamide (PPA, performance Nylon), fluoropolymers (such as, but not limited to, polytetrafluoroethylene (PTFE), fluorinated ethylene propylene (FEP), polyvinylidene fluoride or polyvinylidene difluoride (PVDF), polychlorotrifluoroethylene (PCTFE), perfluoroalkoxy alkane (PFA), or the like), high density polyethylene (HDPE), ultra-high molecular weight polyethylene (UHMWPE), epoxy resins, phenolic resins, and the like, their monomers thereof, or any suitable combination thereof. In a preferred embodiment of the invention, the polymer may be a thermosetting polymer.

In some embodiments, the polymer may be an epoxy resin. Any suitable type of epoxy resin may be used, such as a bisphenol epoxy resins, an aliphatic epoxy resins, a novolac epoxy resin, a halogenated epoxy resin, an epoxy resin diluent, and/or a glycidylamine epoxy resin.

In some embodiments, the matrix material may comprise two or more polymers. The two or more polymers may be the same type of polymer or may be of different types.

The matrix material may comprise any suitable portion of the composite material. For instance, in some embodiments of the invention, the matrix material may comprise between about 25 wt % and 99.95 wt % of the composite material. More preferably, the matrix material may comprise between about 45 wt % and 99.9 wt % of the composite material. Most preferably, the matrix material may comprise between about 90 wt % and about 99.5 wt % of the composite material.

In other embodiments of the invention, the plurality of boron nitride structures may be impregnated within a fire-resistant material. The plurality of boron nitride structures may be impregnated within any suitable fire-resistant material, such as, but not limited to, mineral wool, gypsum, asbestos cement, perlite, corriboard, calcium silicate, sodium silicate, potassium silicate, treated lumber plywood, treated vegetable fiber (e.g., cotton, jute, kenaf, hemp, flax and so on), fire-retardant treated wood, brick, concrete, cement render, glass, magnesium oxide, geobond asbestos substitute, polybenzimidazole fiber (PBI), aramid (para or meta), flame retardant cotton, coated nylon, carbon foam (CFOAM), melamine and modacrylic, or any suitable combination thereof.

While the protection device of the present invention provides improved fire resistance over conventional devices, it is envisaged that the protection device may also provide improved mechanical strength and impact resistance. This may be advantageous in extreme weather events in which flying debris may impact upon the protection device at relatively high velocity.

While the present invention could be used to protect internal doors within a structure (thereby isolating certain sections of the structure from other sections in the event of a fire), it is envisaged that, more typically, the present invention may be used to protect the external doors of a structure.

In embodiments of the invention in which the fire-resistant material comprises glass, it is envisaged that the composite material formed from a plurality of boron nitride structures within a glass matrix may be used for other purposes. For instance, a composite material formed from a plurality of boron nitride structures within a glass matrix may be used to provide fire and impact resistance for windows in structures, vehicles and the like.

Preferably, the present invention complies with all relevant local building codes and standards, as well as all relevant local fire and storm safety codes and standards.

In a second aspect, the invention resides broadly in a protection device comprising one or more sheet members, the one or more sheet members being configured to substantially overlie a panel, and wherein the one or more sheet members comprise one or more layers of impact resistant material, and wherein at least one of the one or more layers of impact resistant material comprises a plurality of boron nitride structures, the boron nitride structures comprising one or more forms of crystalline boron nitride structures.

In some embodiments of the invention, the one or more sheet members may be at least semi-permeable to airflow. In some embodiments, the one or more sheet members may comprise a lattice, mesh, or clear film.

The one or more sheet members may be of any suitable form, and of any suitable number. For instance, in some embodiments of the invention, a single sheet member may be provided. In this embodiment of the invention, the single sheet member may overlie substantially the entire panel. In other embodiments of the invention, a plurality of sheet members may be provided. In this embodiment, each of the plurality of sheet members may be configured to overlie a portion of the glass panel. However, it is envisaged that the plurality of sheet members may, together, substantially overlie the entire panel or a plurality of panels.

In some embodiments of the invention, it is envisioned that the panel may be a glass panel. The glass panel may be of any suitable type, such as, but not limited to solar panels, windows, skylights, sun rooves and so on.

The one or more sheet members may be maintained above the glass panel using any suitable technique. For instance, the one or more sheet members may be positioned on one or more spacers. The one or more spaces may be connected to, or otherwise supported by, the panel, or a support associated with or located proximal to, the panel. The sheet members may also be connected to, or otherwise supported by, the one or more spacers.

The one or more spacers may be of any suitable form. For instance, the one or more spacers may be relatively elongate members. Alternatively, the spacers may comprise two or more spacer members configured for movement relative to one another in order to adjust the overall length of the spacer. The spacer members may be configured for any suitable movement relative to one another, such as sliding movement, telescoping movement, hinged movement, pivoting movement and the like, or a combination thereof.

In some embodiments, the one or more sheet members may be provided with a structure that allows for increased tensile strength, increased transparency, and/or reduced weight. For instance, the one or more sheet members may be fabricated with a lattice structure.

In some embodiments the lattice structure may contain a criss-cross or herringbone structure.

In some embodiments the one or more sheet members may comprise a plurality of sheet member layers.

The one or more sheet members may contain a plurality of sheet members having a lattice structure that can slide or pivot to adjust the protection level of the one or more sheet members.

It is envisaged that the one or more spacers may be of sufficient size to space the sheet members and the panel apart from one another. The sheet members and the panel may be spaced apart from one another by any suitable distance. However, it is envisaged that the sheet members and the panel may be spaced apart from one another by a sufficient distance such that the force of impacts on the sheet members (such as from debris, hail and the like) is not transmitted to the panel.

In some embodiments the spacers may be of adjustable length, such that the distance between the panel and the sheet members may be adjusted. This may be beneficial in situations in which, for instance, a storm (such as a hailstorm) is protected and it is desired to increase the distance between the sheet members and the panel. In addition, the spacers may be adjustable such that to the angle of the one or more sheet members relative to the panel may be adjusted. In this embodiment, it is envisaged that the orientation of the sheet members may be adjusted so that the sheet members are movable to a non-planar configuration relative to the panel, for instance such that the one or more sheet members are tilted relative to the panel.

In some embodiments, the sheet members may be detachable from the panel and/or the one or more spacers for easy removal and maintenance.

In some embodiments, the one or more sheet members may be provided with side openings that allow access for cleaning and maintenance without removal. Alternatively, the sheet members may be spaced apart from the panel by a sufficient distance to allow access to the panel in the gap formed between the sheet members and the panel.

The method of attaching or detaching the one or more sheet members to the glass panel and/or the one or more spacers may be achieved using any suitable technique, such as a clamp, clasp, suction cup or appropriate adhesive means. Alternatively, one or more mechanical fasteners (screws, bolts, nails, rivets or the like, or any suitable combination thereof) may be used to attach the one or more sheet members to the glass panel and/or the one or more spacers. In other embodiments, the one or more sheet members may be retained in frictional engagement with the glass panel and/or the one or more spacers.

The one or more sheet members may be fabricated in such a way that they are relatively thin and/or relatively permeable to ultraviolet light.

The one or more sheet members may be provided with heat-dissipative properties. It is envisaged that this may add protective benefits to the glass panel.

The one or more sheet members may be at least partially fabricated from a composite material that exhibits low thermal expansion to improve the structural rigor of the one or more sheet members under sun exposure.

The one or more sheet members may be fabricated from a composite material that exhibits thermal shock resistivity to improve the structural rigor of the one or more sheet members extreme weather exposure.

The one or more sheet members may be fabricated from a composite material that exhibits heat resistant, fire retardant and electrical insulation properties to enhance the safety of using the one or more sheet members to protect solar panels.

The one or more sheet members may be fabricated from a composite material that exhibits hydrophobic or water repellent properties to improve prevent precipitation collecting above solar panels.

The one or more sheet members may be configured to form a housing comprising a cavity substantially large enough to encase a solar panel.

In some embodiments of the invention the housing may be retained in position overlying the solar panel. The housing may be retained in position using any suitable technique, although in one embodiment the housing may be retained in position using one or more fastening members. The fastening members may be of any suitable form, although in some embodiments of the invention the one or more fastening members may comprise mechanical fasteners, such as nails, screws, bolts, rivets or the like. In these embodiments, the mechanical fasteners may be used to retain the housing in position on a support. Alternatively, one or more fasteners in the form of protrusions, hooks, ties, clamps, springs, or the like, or any suitable combination thereof, may be provided.

In this embodiment of the invention, it is envisaged that the housing may comprise a plurality of wall members. Preferably, each wall member may comprise a sheet member. The wall members may be positioned relative to one another so as to at least partially encapsulate the solar panel. Preferably, the wall members may be positioned relative to one another so as to substantially encapsulate the solar panel.

It is envisaged that adjacent sheet members may be connected to one another (for example, at adjacent edges thereof) so as to form the housing. In other embodiments, the housing may comprise one or more frame members configured to be connected to the sheet members to form the housing. The frame members may be fabricated from the composite material, or may be fabricated from another material.

As previously stated, the one or more sheet members may be fabricated from one or more forms of crystalline boron nitride structures. The one or more forms of boron nitride structures may be of any suitable type, such as boron nitride nanotubes, boron nitride ribbon, boron nitride wire, boron nitride sheets, boron nitride nanosheets, boron nitride nano wire or boron nitride nano ribbon. In some embodiments, the one or more sheet members may be fabricated from two or more forms of crystalline boron nitride structures. It is envisaged that the composition of the one or more sheet members may provide thermal management protection for the glass panel.

In a third aspect, the invention resides broadly in a watercraft at least partially fabricated from a composite material comprising a plurality of boron nitride structures, the boron nitride structures comprising one or more forms of crystalline boron nitride structures.

In some embodiments, the composite material may comprise a plurality of boron nitride structures, the boron nitride structures comprising boron nitride nanotubes, or a hybrid of two or more forms of crystalline boron nitride structures, within a matrix material.

Preferably, the hybrid of two or more forms of crystalline boron nitride structures may comprise a combination of boron nitride nanotubes, boron nitride wire, boron nitride ribbon and/or boron nitride nanosheets. The various crystalline boron nitride structures may be present in any suitable concentration. For instance, equal amounts (by weight or by volume) of each of the boron nitride structures may be provided. Alternatively, each form of boron nitride structure may comprise between 0.1% and 99.9% (by weight or by volume) of the total quantity of crystalline boron nitride structures.

In some embodiments, the watercraft may be at least partially fabricated from two or more different types of composite material comprising a plurality of boron nitride structures, the boron nitride structures comprising boron nitride nanotubes, or a hybrid of two or more forms of crystalline boron nitride structures, within a matrix material. In use, it is envisaged that fabricating the watercraft from two or more different types of composite material may provide the watercraft with regions having different properties. For instance, the regions may have different stiffness values, impact resistance, dampening, strength-to-weight ratio, or the like. In other embodiments, the composite materials may include different additives therein, the additives being configured to provide the composite materials with particular physical properties. For instance, it may be desired that the composite material be elastically deformable.

The term watercraft as used herein is broadly defined as an object that may be used during a particular aquatic sporting, recreational or fitness activity. Preferably, the watercraft is an unpowered watercraft. Exemplary devices may include surf skis, surfboards, wakeboards, bodyboards, stand up paddleboards (SUP), skim boards kiteboards, kneeboards, water skis, kayaks, canoes, kite boards, aquatic gliding boards, rafts, dinghies or solid personal floatation devices.

In some embodiments, the watercraft is a surfboard, which has been at least partially fabricated from a composite material, the composite material comprising a plurality of boron nitride structures, the boron nitride structures comprising boron nitride nanotubes, or a hybrid of two or more forms of crystalline boron nitride structures.

Although reference has been made herein to a surfboard, it should be readily apparent that substantially any water sports board can be made in accordance with the present invention.

The material for the watercraft may form a portion of the composition of the structural core, the body material, and/or the device layers and coatings. For example, the composite material may be provided in the form of a surface coating material.

The term “surface coating material” as used herein is broadly defined as a material that may be applied to the surface of an object. Exemplary surface coatings may include paint, varnish, adhesive sheets, and polish.

In some embodiments the watercraft may comprise a surface coating material that contains an additive that is resistant to ultraviolet light exposure, thus increasing the device longevity.

In some embodiments the watercraft may comprise a surface coating material that is configured to increase the water repelling properties of the watercraft, resulting in less drag and enhanced watercraft performance.

Any suitable portion of the watercraft may be at least partially fabricated from a composite material. Generally, the portion may be a portion of the watercraft which may benefit from one or more of improved strength, reduced weight, improved flexibility, improved hydrophobicity, increased durability, and the like. For instance, the portion of the watercraft may comprise a structural portion such as the flexible spine of a surfboard.

In some embodiments of the invention, it is envisioned a plurality of spine portions comprising a composite material may be provided. The spine portions may be of any suitable form, although in a preferred embodiment of the invention, the spine portions may be relatively flexible. It is envisaged that the spine portion may provide the watercraft with one or more of improved strength, reduced weight, improved flexibility, improved hydrophobicity, increased durability, and the like.

In some embodiments of the invention, an inner portion of the watercraft may comprise a composite material, the composite material comprising a plurality of boron nitride structures, the boron nitride structures comprising boron nitride nanotubes, or a hybrid of two or more forms of crystalline boron nitride structures. The inner portion may be of any suitable form, although in some embodiments of the invention the inner portion may comprise a core of the watercraft.

The watercraft may be fabricated from a composite material that exhibits hydrophobic or water repellent properties to enhance the travel speed of the watercraft in water.

The watercraft may be fabricated from a composite material that exhibits reduce weight with increased tensile strength to enhance the durability of the watercraft.

The watercraft may be fabricated to comprise a surface coating comprising a composite material that exhibits a protective layer to enhance the shock resistivity of the watercraft to external forces.

In some embodiments of the invention the watercraft comprising the composite material may have a reduced weight and increased tensile strength that increases the performance of the watercraft.

In some embodiments of the invention the watercraft comprising the composite material may have increased flexibility that increases the performance of the watercraft.

In some embodiments of the invention the watercraft comprising the composite material has increased hydrophobicity that increases the performance of the watercraft.

It is envisaged that the composite material may provide the watercraft with improved resistance to cracking and impact damage due to the properties of the composite material.

In some embodiments of the invention, the watercraft may comprise a solid foam core coated in one or more layers of the composite material. In some embodiments, an adhesive resin or epoxy applied to an outer surface of the watercraft may comprise the composite material.

In some embodiments of the invention the watercraft may contain a stringer comprising the composite material such that the watercraft has increased flexibility to improve performance and structural integrity.

In some embodiments of the invention the watercraft may contain a stringer comprising the composite material such that the stringer does not expand or shrink with changes in temperature, thus increasing the structural integrity of the watercraft.

It is envisaged that the composite material from which the watercraft is at least partially fabricated may provide the watercraft with the advantageous properties discussed herein. More specifically, the boron nitride structures, or combination of boron nitride structures may provide the watercraft with the advantageous properties discussed herein.

Thus, in a fourth aspect, the invention resides broadly in a composite material comprising a plurality of boron nitride structures dispersed within a glass matrix, the boron nitride structures comprising one or more forms of crystalline boron nitride structures.

The composite material may comprise any suitable weight percent of boron nitride structures in the glass matrix material. For instance, the composite material may comprise between about 0.05 wt % and about 75 wt % boron nitride structures. More preferably, the composite material may comprise between about 0.1 wt % and about 55 wt % boron nitride structures. Still more preferably, the composite material may comprise between about 0.5 wt % and about 50 wt % boron nitride structures. Yet more preferably, the composite material may comprise between about 0.5 wt % and about 30 wt % boron nitride structures. Even more preferably, the composite material may comprise between about 0.5 wt % and about 20 wt % boron nitride structures. Still more preferably the composite material may comprise between about 0.5 wt % and about 10 wt % boron nitride structures.

In a fifth aspect, the invention resides broadly in a window pane fabricated from the composite material of the fourth aspect.

The window pane may be of any suitable form, and may be configured for use in a building structure, a vehicle and the like.

As previously discussed, the one or more panels members of the first aspect of the invention may be at least somewhat flexible and may be wound onto a reel in the storage condition, and wound off the reel into the use condition. It is envisaged that arrangement may also be used to protect other objects from extreme weather events.

Thus, in a sixth aspect the invention resides broadly in a fire protection device comprising a reel member mounted to an object, a fire protection member movable between a storage condition in which the fire protection member is at least partially wound about the reel member, and a use condition in which the fire protection member is unwound from the reel to overlie at least a portion of the object, and wherein fire protection member comprises a plurality of boron nitride structures, the boron nitride structures comprising one or more forms of crystalline boron nitride structures.

The object may be of any suitable form. For instance, the object may comprise a building structure, vehicle, or the like.

The reel may be permanently mounted to the object, or may be configured for removable connection thereto. It is envisaged that in some circumstances (such as if the object comprises a fire engine or similar emergency vehicle) the fire protection device may be mounted permanently to the object.

The fire protection member may be moved from the storage condition to the use condition using any suitable technique. The fire protection member may be moved between the storage condition and the use condition manually, or automatically. For instance, the fire protection device may further comprise an actuator, such as a motor, ram or the like, configured to move the fire protection member between the storage condition and the use condition.

Actuation of the actuator may be controlled by a user. For instance, a user may be required to actuate the actuator manually (such as by flicking a switch or lever, pressing a button and so on) to actuate movement of the fire protection member between the storage condition and the use condition. In other embodiments of the invention, the actuator may be configured to move the fire protection member between the storage condition and the use condition automatically in response to one or more environmental parameters.

The one or more environmental parameters may be of any suitable form, and may include temperature (or a change in temperature), barometric pressure (or a change in barometric pressure), windspeed (or a change in windspeed), air quality (or a change in air quality) or the like, or any suitable combination thereof.

In these embodiments, it is envisaged that the one or more environmental parameters may indicate the presence of bushfires, or at least the right environmental conditions for bushfires to occur.

In some embodiments of the invention, the fire protection device may comprise one or more sensors configured to measure the one or more environmental parameters. Thus, the one or more sensors may comprise temperature sensors, barometers, anemometers, air quality monitors or the like, or any suitable combination thereof. Preferably, the one or more sensors may be mounted to, or otherwise associated with, the object.

The one or more sensors may be associated with a computing device configured to receive measurements of the environmental parameters measured by the one or more sensors. The computing device may be of any suitable form, although in a preferred embodiment of the invention, the computing device may be configured to determine whether the environmental parameters (or a change in the environmental parameters) meet or exceed a predetermined value at which the fire protection member is moved from the storage condition to the use condition.

It is envisaged that, when the predetermined value of the environmental parameters is met or exceeded, the computing device may communicate with the actuator. The actuator may then be actuated to move the fire protection member from the storage condition to the use condition.

Similarly, when the extreme weather event is over and the one or more sensors detect that the environmental parameters (or a change in the environmental parameters) are not met or exceeded, the actuator may be actuated to move the fire protection member from the use condition to the storage condition.

In some embodiments, a plurality of fire protection devices may be associated with the object. The plurality of fire protection devices may be positioned adjacent one another, such that, when in the use condition, fire protection members of the plurality of fire protection devices may together substantially overlie the entire object.

The fire protection member may be of any suitable form. Preferably, however, the fire protection member may comprise a flexible member. Preferably, the fire protection member may be formed from sheet material having one or more layers. At least one of the one or more layers may comprise a plurality of boron nitride structures.

In some embodiments, the fire protection member may comprise one or more layers of fire-resistant material. In some embodiments of the invention, the fire protection member may comprise a single layer, the single layer being fabricated from a fire-resistant material. In other embodiments of the invention, the fire protection member may comprise a plurality of layers, and at least one of the plurality of layers may be fabricated from fire-resistant material.

The layers may be entirely fabricated from a fire-resistant material, or may be partially fabricated from a fire-resistant material. In a preferred embodiment of the invention, an outermost layer of the fire protection member (i.e., a layer located furthest from the object the fire protection member overlies) may be fabricated from the fire-resistant material. In some embodiments, the layer of fire-resistant material may comprise a surface coating layer on an external surface of the fire protection member.

In some embodiments of the invention, one or more layers of the fire protection member may be fabricated from conventional materials, such as fabric, polymer or the like. In these embodiments, one or more layers of fire-resistant material may be placed on the conventional layers. Alternatively, the fire protection member may be fabricated from one or more layers of fire-resistant material only.

In embodiments of the invention in which the fire protection member comprises a plurality of layers, it is envisaged that the plurality of layers may be joined or bonded together. This may be achieved using any suitable technique, such as, but not limited to, adhesives, laminating, the use of mechanical fasteners and the like, or any suitable combination thereof.

As previously stated, at least one of the one or more layers of fire-resistant material comprises a plurality of boron nitride structures, the boron nitride structures comprising one or more forms of crystalline boron nitride structures.

In some embodiments of the invention, the layer of fire-resistant material comprising a plurality of boron nitride structures may comprise a surface coating material. In some embodiments of the invention, the surface coating material may comprise a paint, varnish or the like. The paint may be applied to an outer surface of the fire protection member using techniques including spray (air atomized, airless, electrostatic, high volume-low pressure) brushing, and dipping. The paint may include one or more further components. In these embodiments, the one or more further components may comprise polymers (such as, but not limited to, nitrocellulose, tosylamide-formaldehyde resin or acrylate copolymer), plasticisers (such as, but not limited to diethylphthalate, dibutylphthalate or camphor), pigments (such as, but not limited to chromium oxide greens, chromium hydroxide, ferric ferrocyanide, stannic oxide, titanium dioxide, iron oxide, carmine, ultramarine, manganese violet, mica, bismuth oxychloride, natural pearls or aluminum powder), thickeners (such as, but not limited to, stearalkonium hectorite) and/or UV-stabilisers (such as, but not limited to, benzophenone-1).

In some embodiments of the invention, the surface coating material may comprise an intumescent paint.

The surface coating material may comprise any suitable weight percent boron nitride structures. For instance, the surface coating material may comprise between about 0.05 wt % and about 60 wt % boron nitride structures. More preferably, the surface coating material may comprise between about 0.1 wt % and about 55 wt % boron nitride structures. Still more preferably, the surface coating material may comprise between about 0.5 wt % and about 50 wt % boron nitride structures. Yet more preferably, the surface coating material may comprise between about 0.5 wt % and about 30 wt % boron nitride structures. Even more preferably, the surface coating material may comprise between about 0.5 wt % and about 20 wt % boron nitride structures. Still more preferably the surface coating material may comprise between about 0.5 wt % and about 10 wt % boron nitride structures.

Preferably, the surface coating material comprises a settable, curable or hardenable material. In a preferred embodiment of the invention, the boron nitride structures may be substantially homogenously distributed in the surface coating material once set or hardened.

In other embodiments of the invention, the layer of fire-resistant material comprising a plurality of boron nitride structures may be in the form of a composite material. In this embodiment of the invention, the layer of fire-resistant material may comprise a matrix material impregnated with a plurality of boron nitride structures. The matrix material may be of any suitable form, and may comprise a polymer, a metal and/or a ceramic matrix material.

Any suitable polymer may be used. For instance, the polymer may be polyethylene, polypropylene, polystyrene, polyvinyl chloride, polyether sulphones, acrylonitrile butadiene styrene, polyether polyols, polyester polyols, polyacetal or polyoxymethylene (acetal, POM), polycarbonates, elastomers, thermoplastic elastomers, thermoplastic polyester, thermoplastic polyurethane, polyketones (such as but not limited to polyaryletherketone (PAEK), polyetheretherketone (PEEK), polyetherketoneketone (PEKK) or the like), acrylate polymers, poly(methyl methacrylate) (PMMA), polyphenylene sulfide (PPS), polyamides, polyphthalamide (PPA, performance Nylon), fluoropolymers (such as, but not limited to, polytetrafluoroethylene (PTFE), fluorinated ethylene propylene (FEP), polyvinylidene fluoride or polyvinylidene difluoride (PVDF), polychlorotrifluoroethylene (PCTFE), perfluoroalkoxy alkane (PFA), or the like), high density polyethylene (HDPE), ultra-high molecular weight polyethylene (UHMWPE), epoxy resins, phenolic resins, and the like, their monomers thereof, or any suitable combination thereof. In a preferred embodiment of the invention, the polymer may be a thermosetting polymer.

In some embodiments, the polymer may be an epoxy resin. Any suitable type of epoxy resin may be used, such as a bisphenol epoxy resins, an aliphatic epoxy resins, a novolac epoxy resin, a halogenated epoxy resin, an epoxy resin diluent, and/or a glycidylamine epoxy resin.

In some embodiments, the matrix material may comprise two or more polymers. The two or more polymers may be the same type of polymer or may be of different types.

The matrix material may comprise any suitable portion of the composite material. For instance, in some embodiments of the invention, the matrix material may comprise between about 25 wt % and 99.95 wt % of the composite material. More preferably, the matrix material may comprise between about 45 wt % and 99.9 wt % of the composite material. Most preferably, the matrix material may comprise between about 90 wt % and about 99.5 wt % of the composite material.

In other embodiments of the invention, the plurality of boron nitride structures may be impregnated within a fire-resistant material. The plurality of boron nitride structures may be impregnated within any suitable fire-resistant material, such as, but not limited to, mineral wool, gypsum, asbestos cement, perlite, corriboard, calcium silicate, sodium silicate, potassium silicate, treated lumber plywood, treated vegetable fiber (e.g., cotton, jute, kenaf, hemp, flax and so on), fire-retardant treated wood, brick, concrete, cement render, glass, magnesium oxide, geobond asbestos substitute, polybenzimidazole fiber (PBI), aramid (para or meta), flame retardant cotton, coated nylon, carbon foam (CFOAM), melamine and modacrylic, or any suitable combination thereof.

In some embodiments of the invention, the fire protection member may be configured for removal from the reel member. In this embodiment, it is envisaged that a person could remove the fire protection device from the reel member and wrap the fire protection device about their body if caught in an extreme weather event, such as a bushfire.

In a seventh aspect, the invention resides broadly in a fire protection device configured for mounting relative to an object, the fire protection device comprising one or more fire protection members movable between a storage condition and a use condition in which the one or more fire protection members substantially overlie the object, wherein the one or more fire protection members comprises a plurality of boron nitride structures, the boron nitride structures comprising one or more forms of crystalline boron nitride structures, the fire protection device further comprising an actuation member associated with the one or more fire protection members, wherein, upon actuation of the actuation member, the one or more fire protection members are moved from the storage condition to the use condition.

In some embodiments of the invention, the fire protection members may be associated with one or more release members when in the storage condition. The one or more release members may be of any suitable form, although in some embodiments of the invention the one or more release members may comprise one or more protrusions, hooks, ties, clamps, springs, or the like, or any suitable combination thereof. Preferably, the one or more release members may retain the one or more fire protection members in the storage condition.

In some embodiments of the invention, the fire protection device further comprises a deployment enhancement device. The deployment enhancement device may be of any suitable form, although it is envisaged that the deployment enhancement device may be configured to enhance the speed at which the one or more fire protection members are moved, or deployed, from the storage condition to the use condition. This may be of particular important in situations in which, for instance, the object comprises a vehicle caught in a bushfire.

The deployment enhancement device may be of any suitable form. For instance, the deployment enhancement may comprise an explosive charge, an inflation device, a device configured to contain and/or release fluid at a relatively high pressure or the like, or any suitable combination thereof.

It is envisaged that the one or more release members may be associated with the actuation member. In these embodiments of the invention, actuation of the actuation member may result in the one or more release members releasing the one or more fire protection members for movement from the storage condition to the use condition.

The actuation member may be associated with the one or more release members via any suitable technique. For instance, the actuation member may be physically connected to the one or more release members, such that actuation of the actuation member results in movement of the one or more release members to release the one or more fire protection members for movement from the storage condition to the use condition. Alternatively, the actuation member may be electronically connected to the one or more release members such that, upon actuation of the actuation member, an electronic signal may be sent to the one or more release members to release the one or more fire protection members for movement from the storage condition to the use condition.

In some embodiments of the invention, the actuation member may be located in close proximity to the one or more release members. In other embodiments, the actuation member may be located remote from the one or more release members. For instance, the actuation member may be located within a structure, within the cabin of a vehicle or the like. In some embodiments of the invention, the actuation member may be provided on, or actuated using, an electronic device, such as a mobile phone, smart watch, remote control or the like carried by a person.

The one or more fire protection members may be mounted relative to any suitable part of the object. In a preferred embodiment of the invention, however, the one or more fire protection members may be mounted relative to an upper portion of the object, such as a roof. In this way, upon actuation of the actuation member, the fire protection members may move at least partially under the effect of gravity to overlie the object.

In some embodiments of the invention, the one or more fire protection members may be rolled when in the storage condition. Thus, as the fire protection members move from the storage condition to the use condition, the fire protection members unroll to overlie the object.

It is envisaged that, in the use condition, the fire protection member may be secured in place. In this way, unwanted movement of the fire protection member may be reduced or eliminated. The fire protection member may be secured in place using any suitable technique. For instance, the fire protection member may be provided with one or more connection members (hooks, ties, loops etc.) configured to engage with a support surface or a complementary connection member (such as a screw-threaded member, twist lock member, snap lock member, frictional fitting or the like) located on a support surface. Alternatively, at least a portion of the fire protection member (such as a lower portion of the fire protection member) may be received and retained in a receiving portion associated with a support surface.

In embodiments of the invention in which a single fire protection member is provided, it is envisaged that actuation of the actuation member may result in the fire protection member moving to overlie substantially the entire object. In embodiments of the invention in which a plurality of fire protection members are provided, it is envisaged that actuation of the actuation member may result in the simultaneous movement of all of the plurality of fire protection members from the storage condition to the use condition.

The fire protection member may be of any suitable form. Preferably, however, the fire protection member may comprise a flexible member. Preferably, the fire protection member may be formed from sheet material having one or more layers. At least one of the one or more layers may comprise a plurality of boron nitride structures.

In some embodiments, the fire protection member may comprise one or more layers of fire-resistant material. In some embodiments of the invention, the fire protection member may comprise a single layer, the single layer being fabricated from a fire-resistant material. In other embodiments of the invention, the fire protection member may comprise a plurality of layers, and at least one of the plurality of layers may be fabricated from fire-resistant material.

The layers may be entirely fabricated from a fire-resistant material, or may be partially fabricated from a fire-resistant material. In a preferred embodiment of the invention, an outermost layer of the fire protection member (i.e., a layer located furthest from the object the fire protection member overlies) may be fabricated from the fire-resistant material. In some embodiments, the layer of fire-resistant material may comprise a surface coating layer on an external surface of the fire protection member.

In some embodiments of the invention, one or more layers of the fire protection member may be fabricated from conventional materials, such as fabric, polymer or the like. In these embodiments, one or more layers of fire-resistant material may be placed on the conventional layers. Alternatively, the fire protection member may be fabricated from one or more layers of fire-resistant material only.

In embodiments of the invention in which the fire protection member comprises a plurality of layers, it is envisaged that the plurality of layers may be joined or bonded together. This may be achieved using any suitable technique, such as, but not limited to, adhesives, laminating, the use of mechanical fasteners and the like, or any suitable combination thereof.

As previously stated, at least one of the one or more layers of fire-resistant material comprises a plurality of boron nitride structures, the boron nitride structures comprising one or more forms of crystalline boron nitride structures.

In some embodiments of the invention, the plurality of boron nitride structures may comprise a surface coating material applied to at least one of the one or more layers of fire-resistant material. In some embodiments of the invention, the surface coating material may comprise a paint, varnish or the like. The paint may be applied to an outer surface of the fire protection member using techniques including spray (air atomized, airless, electrostatic, high volume-low pressure) brushing, and dipping. The paint may include one or more further components. In these embodiments, the one or more further components may comprise polymers (such as, but not limited to, nitrocellulose, tosylamide-formaldehyde resin or acrylate copolymer), plasticisers (such as, but not limited to diethylphthalate, dibutylphthalate or camphor), pigments (such as, but not limited to chromium oxide greens, chromium hydroxide, ferric ferrocyanide, stannic oxide, titanium dioxide, iron oxide, carmine, ultramarine, manganese violet, mica, bismuth oxychloride, natural pearls or aluminum powder), thickeners (such as, but not limited to, stearalkonium hectorite) and/or UV-stabilisers (such as, but not limited to, benzophenone-1).

In some embodiments of the invention, the surface coating material may comprise an intumescent paint.

The surface coating material may comprise any suitable weight percent boron nitride structures. For instance, the surface coating material may comprise between about 0.05 wt % and about 60 wt % boron nitride structures. More preferably, the surface coating material may comprise between about 0.1 wt % and about 55 wt % boron nitride structures. Still more preferably, the surface coating material may comprise between about 0.5 wt % and about 50 wt % boron nitride structures. Yet more preferably, the surface coating material may comprise between about 0.5 wt % and about 30 wt % boron nitride structures. Even more preferably, the surface coating material may comprise between about 0.5 wt % and about 20 wt % boron nitride structures. Still more preferably the surface coating material may comprise between about 0.5 wt % and about 10 wt % boron nitride structures.

Preferably, the surface coating material comprises a settable, curable or hardenable material. In a preferred embodiment of the invention, the boron nitride structures may be substantially homogenously distributed in the surface coating material once set or hardened.

In other embodiments of the invention, the layer of fire-resistant material comprising a plurality of boron nitride structures may be in the form of a composite material. In this embodiment of the invention, the layer of fire-resistant material may comprise a matrix material impregnated with a plurality of boron nitride structures. The matrix material may be of any suitable form, and may comprise a polymer, a metal and/or a ceramic matrix material.

Any suitable polymer may be used. For instance, the polymer may be polyethylene, polypropylene, polystyrene, polyvinyl chloride, polyether sulphones, acrylonitrile butadiene styrene, polyether polyols, polyester polyols, polyacetal or polyoxymethylene (acetal, POM), polycarbonates, elastomers, thermoplastic elastomers, thermoplastic polyester, thermoplastic polyurethane, polyketones (such as but not limited to polyaryletherketone (PAEK), polyetheretherketone (PEEK), polyetherketoneketone (PEKK) or the like), acrylate polymers, poly(methyl methacrylate) (PMMA), polyphenylene sulfide (PPS), polyamides, polyphthalamide (PPA, performance Nylon), fluoropolymers (such as, but not limited to, polytetrafluoroethylene (PTFE), fluorinated ethylene propylene (FEP), polyvinylidene fluoride or polyvinylidene difluoride (PVDF), polychlorotrifluoroethylene (PCTFE), perfluoroalkoxy alkane (PFA), or the like), high density polyethylene (HDPE), ultra-high molecular weight polyethylene (UHMWPE), epoxy resins, phenolic resins, and the like, their monomers thereof, or any suitable combination thereof. In a preferred embodiment of the invention, the polymer may be a thermosetting polymer.

In some embodiments, the polymer may be an epoxy resin. Any suitable type of epoxy resin may be used, such as a bisphenol epoxy resins, an aliphatic epoxy resins, a novolac epoxy resin, a halogenated epoxy resin, an epoxy resin diluent, and/or a glycidylamine epoxy resin.

In some embodiments, the matrix material may comprise two or more polymers. The two or more polymers may be the same type of polymer or may be of different types.

The matrix material may comprise any suitable portion of the composite material. For instance, in some embodiments of the invention, the matrix material may comprise between about 25 wt % and 99.95 wt % of the composite material. More preferably, the matrix material may comprise between about 45 wt % and 99.9 wt % of the composite material. Most preferably, the matrix material may comprise between about 90 wt % and about 99.5 wt % of the composite material.

In other embodiments of the invention, the plurality of boron nitride structures may be impregnated within a fire-resistant material. The plurality of boron nitride structures may be impregnated within any suitable fire-resistant material, such as, but not limited to, mineral wool, gypsum, asbestos cement, perlite, corriboard, calcium silicate, sodium silicate, potassium silicate, treated lumber plywood, treated vegetable fiber (e.g., cotton, jute, kenaf, hemp, flax and so on), fire-retardant treated wood, brick, concrete, cement render, glass, magnesium oxide, geobond asbestos substitute, polybenzimidazole fiber (PBI), aramid (para or meta), flame retardant cotton, coated nylon, carbon foam (CFOAM), melamine and modacrylic, or any suitable combination thereof.

Although the fire protection member has been described largely in terms of its fire-resistant properties, it is envisaged that the fire protection member may also be provided with impact resistant properties. In this embodiment, it is envisaged that the fire protection member may be resistant to damage from impact by objects and debris that may occur during high wind events (storms, cyclones or the like).

In these embodiments, the fire protection member may be provided with one or more apertures therein. The one or more apertures may be of any suitable size of shape, although it is envisaged that the one or more apertures may be provided to allow for the passage of air therethough while retaining the fire protection member substantially in place. Thus, the fire protection member may be prevented from excessive movement caused by relatively high winds.

In embodiments of the invention in which the fire protection member is associated with a building, the fore protection member may be located on any suitable portion of the building. For instance, the fire protection member may be associated with an eave of a building, the roof of a building, guttering or the like. Preferably, however, when the fire protection member is in the use condition, the fire protection member is spaced apart from a wall of the building.

In an eighth aspect, the invention resides broadly in a fire protection device comprising a flexible sheet member, configured to be placed about a body of a user, and wherein the fire protection device is fabricated from one or more layers of sheet material, at least one of the layers of sheet material including a plurality of boron nitride structures, and wherein the boron nitride structures comprise one or more forms of crystalline boron nitride structures.

In some embodiments, the fire protection device may be provided in the form of an elongate sheet member. In other embodiments, the fire protection device may be in the form of a tube, sheath or the like.

The fire protection device may be of any suitable size. For instance, the fire protection device may be of sufficient size to accommodate one person. Alternatively, the fire protection device may be of sufficient size to accommodate a plurality of people.

It is envisaged that the composition and construction of the fire protection device may be substantially the same as that of the fire protection members of the fifth aspect of the invention.

In a ninth aspect, the invention resides broadly in a structural element for the construction of a structure, the construction panel comprising the one or more panel members of the first aspect of the invention.

In a tenth aspect, the invention resides broadly in a firearm barrel comprising:
An elongate body defining a bore and a bore axis;
The body defining a breech end and an opposed muzzle end;
The bore having an inner surface comprising at least one helical groove thereon; and
Wherein the body is fabricated from a material including a plurality of boron nitride structures, wherein the boron nitride structures comprise one or more forms of crystalline boron nitride structures.

In some embodiments of the invention, the entire body of the firearm barrel may be fabricated from the material including a plurality of boron nitride structures. In other embodiments of the invention, such as where the firearm barrel is fabricated from two or more materials, at least one of the materials may comprise the material including a plurality of boron nitride structures.

Preferably, the material including a plurality of boron nitride structures may be in the form of a composite material. In this embodiment of the invention, the material may comprise a matrix material impregnated with a plurality of boron nitride structures. The matrix material may be of any suitable form, and may comprise a polymer, a metal and/or a ceramic matrix material.

In a preferred embodiment of the invention, the matrix material may comprise a metal, such as, but not limited to, steel, stainless steel or aluminium. It is envisaged that the addition of a plurality of boron nitride structures within the metal matrix may have the effect of reducing the mass of the firearm barrel, as well as increasing the rigidity and mechanical strength of the firearm barrel.

In some embodiments of the invention, the material including a plurality of boron nitride structures may be applied to a surface of the firearm barrel. In particular, it is envisaged that the firearm barrel may be of substantially conventional construction, and the material including a plurality of boron nitride structures may be applied to the outer surface thereof. For instance, the material including a plurality of boron nitride structures may be painted or coated onto the surface of the firearm barrel. Alternatively, the material including a plurality of boron nitride structures may comprise a composite material that is applied about the circumference of the firearm barrel. For instance, the composite material may be tubular in shape and configured to surround the firearm barrel along at least a portion of the length thereof. Alternatively, the composite material may be wound or otherwise positioned around the circumference of the firearm barrel along at least a portion of the length thereof. In this embodiment of the invention, the composite material may be in the form of a prepreg. The prepreg may be of any suitable form, and may comprise a matrix material (and in particular, a polymer matrix material such as epoxy or phenolic resin) impregnated with fibres (such as, but not limited to fibreglass, polyaramid or the like) and impregnated and/or coated with the boron nitride structures.

In some embodiments of the invention, the prepreg may be applied to the outer surface of a conventional firearm barrel. More preferably, however, the diameter of the firearm barrel may be reduced along the portion of the length of the firearm barrel to which the prepreg is to be applied. In this embodiment, it is envisaged that the diameter of the firearm barrel in the region to which the prepreg is applied may be substantially identical to the diameter of a conventional firearm barrel.

It is envisaged that the firearm barrel of the present invention will be lighter and more rigid than conventional firearm barrels, and the presence of the boron nitride structures will assist in the rapid dissipation of heat in the firearm barrel when the firearm is discharged.

It will be understood that, in the present invention, the term “firearm barrel” is intended to refer to a barrel of any suitable firearm. This may include small arms, light weapons, heavy weapons and so on. The firearm barrel may be of any suitable calibre.

In an eleventh aspect, the present invention resides in a wear component comprising a plurality of boron nitride structures dispersed within a polymer matrix, the boron nitride structures comprising one or more forms of crystalline boron nitride structures.

The wear component may be of any suitable form, and may be used in equipment such as mining, drilling, tunnelling and construction equipment (borers, crushers, grinding machines, conveyors and so on) and vehicles (excavators, stacker/reclaimers, haul trucks and the like) and so on. In these embodiments of the invention, the wear component may comprise a wear plate, mill liner, truck liner, tooth (such as a bucket or excavator tooth, crusher tooth, drill tooth and so on), drill tip, drill head or drill bit or the like, or any suitable combination thereof. In embodiments of the invention in which the wear component forms part of a crusher, the wear component may comprise at least a portion of a jaw, cone, roll or the like. In embodiments of the invention in which the wear component forms part of a conveyor system, the wear component may comprise at least a portion of a conveyor belt, roller, scraper or the like.

In some embodiments, the wear component may be used to reduce or eliminate wet abrasion erosion. For instance, the wear component may be used in applications in which the wear component is exposed to a slurry, and, in particular an abrasive slurry. The slurry may be of any suitable form, although in a preferred embodiment of the invention, the slurry may comprise a liquid containing abrasive particles, such as mineral particles. Thus, the slurry may comprise a mineral slurry.

Thus, in this embodiment, the wear component may be used in slurry handling equipment. The slurry handling equipment may be of any suitable form such as, but not limited to, hydrocyclones, pumps, pipes, chutes, impellers, tanks, flotation cells, screens, screen decks, thickeners, clarifiers, scrubbers, grinding mills and the like.

In some embodiments, the wear component may comprise a linear for slurry handling equipment. The liner may be configured tor connection to the slurry handling equipment using any suitable technique. For instance, the liner may be connected to the slurry handling equipment via adhesives, one or more heat treatments, mechanical fasteners or the like, or any suitable combination thereof. Alternatively, the liner may be provided with one or more connection members configured to connect to complementary connection members on the slurry handling equipment.

It is envisaged that, when connected to the slurry handling equipment, the wear component may at least partially cover a surface of the slurry handling equipment exposed to a slurry during use. More preferably, the wear component may, when connected to the slurry handling equipment, substantially cover a surface of the slurry handling equipment exposed to a slurry during use. Preferably, the wear component may be used to reduce or eliminate slurry coming into contact with surfaces of the slurry handling equipment. In this way, the wear component may be subject to wet abrasion erosion instead of the slurry handling equipment.

It will be understood that the surface of the slurry handling equipment protected by the wear component will depend on the nature of the slurry handling equipment. However, where the slurry handling equipment comprises pipes, pumps, hydrocyclones, tanks, thickeners, clarifiers, flotation cells and the like, the liner may be located on an internal surface of the slurry handling equipment.

Any suitable polymer matrix may be used. For instance, the polymer matrix may comprise an epoxy or phenolic resin. Alternatively, the polymer matrix may comprise polyurethane, rubber or the like.

Preferably, the composite material may comprise between about 0.05 wt % and about 60 wt % boron nitride structures. More preferably, the composite material may comprise between about 0.1 wt % and about 55 wt % boron nitride structures. Still more preferably, the composite material may comprise between about 0.5 wt % and about 50 wt % boron nitride structures. Yet more preferably, the composite material may comprise between about 0.5 wt % and about 30 wt % boron nitride structures. Even more preferably, the composite material may comprise between about 0.5 wt % and about 20 wt % boron nitride structures. Still more preferably the composite material may comprise between about 0.5 wt % and about 10 wt % boron nitride structures.

The boron nitride structures may be of any suitable form. Preferably, the boron nitride structures may comprise one or more forms of crystalline boron nitride structures, such as nanotubes, nanoplates, boron nitride ribbon, boron nitride wire, boron nitride sheets, boron nitride nanosheets, boron nitride nano wire, boron nitride nano ribbon, or any combination thereof.

Advantageously, the wear component of the present invention may be flexible and/or elastic. In this way, the wear component may be manipulated to conform to differently shaped surfaces. For instance, the flexibility and/or elasticity of the wear component may allow the wear component to be applied to a pipe having a circular cross-section, a curved wall of a flotation cell, the surface of an impeller or a pump cavity. It will be understood that the term “manipulated” is intended to indicate that the wear component may be folded, bent, curved or otherwise deformed in order to conform to the shape of the surface of the slurry handling equipment to which it is to be applied.

In addition, it is envisaged that the wear component of the present invention may improve a number of mechanical properties of a wear component in which the boron nitride structures are not present.

For instance, a wear component including boron nitride structures has been shown to have the following improved mechanical properties:

### Abrasion Resistance

30%-45% improvement over polyurethane alone due to reduced interfacial shear and sliding friction.

### Tear and Gouge Resistance

25%-35% over improvement over polyurethane alone due to crack arrest from nanosheet bridging.

### Thermal Stability Under Sliding Wear

20% improvement over polyurethane alone due to heat distribution via high thermal conductivity.

### Slurry Erosion Rate

10%-20% improvement over polyurethane alone due to boron nitride basal plane lubricity reducing particle cutting.

### Service Life in Slurry Duty

30%-50% improvement over polyurethane alone due to combined mechanical, thermal and frictional benefits.

The wear component may be manufactured using any suitable technique. For instance, the wear component may be manufactured by casting, mixing (including high shear mixing), extrusion, sonication, milling dispersion and the like, or a combination thereof.

In a further aspect, the invention resides broadly in a slurry handling equipment liner, the slurry handling equipment liner comprising a plurality of crystalline boron nitride structures dispersed within a polymer matrix.

In a twelfth aspect, the invention resides broadly in a flowable polymer composition, the flowable polymer composition comprising plurality of boron nitride structures dispersed within a polymer matrix, the boron nitride structures comprising one or more forms of crystalline boron nitride structures.

The flowable polymer composition may be of any suitable form, although in a preferred embodiment of the invention the flowable polymer composition may comprise sealant, caulk or the like.

The polymer matrix may be of any suitable form. In some embodiments, the polymer matrix may comprise acrylic, such as acrylic latex, polyurethane, silicone, polysulfide, silane-modified polymer, or the like, or any suitable combination thereof.

Preferably, the flowable polymer composition may comprise between about 0.05 wt % and about 60 wt % boron nitride structures. More preferably, the flowable polymer composition may comprise between about 0.1 wt % and about 55 wt % boron nitride structures. Still more preferably, the flowable polymer composition may comprise between about 0.5 wt % and about 50 wt % boron nitride structures. Yet more preferably, the flowable polymer composition may comprise between about 0.5 wt % and about 30 wt % boron nitride structures. Even more preferably, the flowable polymer composition may comprise between about 0.5 wt % and about 20 wt % boron nitride structures. Still more preferably the flowable polymer composition may comprise between about 0.5 wt % and about 10 wt % boron nitride structures.

In some embodiments of the invention, the flowable polymer composition may comprise a settable or curable composition. In this embodiment, it is envisaged that after the application of the flowable polymer composition, the flowable polymer composition may set or cure to form an at least partially solid material.

In some embodiments of the invention, the flowable polymer composition may be used to seal gaps, such as gaps in window or door frames (for instance to reduce or eliminate embers from a fire from entering a building through the gaps). The flowable polymer composition may be applied in any suitable manner, although in some embodiments of the invention the flowable polymer composition may be applied using an applicator, such as, but not limited to, a caulking gun.

In a thirteenth aspect, the invention resides broadly in a photovoltaic system comprising one or more perovskite solar cells, the one or more perovskite solar cells comprising one or more layers of anti-degradation material, wherein at least one of the one or more layers of anti-degradation material comprises a plurality of boron nitride structures, the boron nitride structures comprising one or more forms of crystalline boron nitride structures.

Perovskite solar cells utilise perovskite-structured materials to convert sunlight into electricity. The perovskite-structured materials refer to a specific arrangement of atoms that form a crystal lattice, named after the mineral perovskite, which has the chemical formula ABX3. In perovskite solar cells, the A-site is typically occupied by an organic cation like methylammonium (MA) or formamidinium (FA), the B-site by a metal cation like lead (Pb) or tin (Sn), and the X-site by a halide ion such as iodide (I), bromide (Br), or chloride (Cl).

Perovskite solar cells have gained significant attention in recent years due to their rapidly increasing power conversion efficiencies (PCEs), relatively low production costs, and potential for flexible and lightweight applications. However, perovskite solar cells may face several challenges, including stability issues related to material degradation in the presence of moisture, oxygen, or light, as well as potential toxicity concerns associated with lead-containing perovskite formulations. It is envisaged that protecting perovskite solar cells may be necessary to mitigate the adverse effects of environmental factors on their performance and longevity.

In some embodiments of the invention, the one or more layers of anti-degradation material comprising a plurality of boron nitride structures may be optically transparent. The one or more layers of anti-degradation material comprising a plurality of boron nitride structures may block or attenuate ultraviolet (UV) radiation. By blocking or attenuation UV radiation, the anti-degradation material may ensure that UV radiation is substantially precluded or eliminated from reaching lower layers of the perovskite solar cells. Further, the one or more layers of anti-degradation material comprising a plurality of boron nitride structures may be arranged to substantially preclude or eliminate water intrusion into the cells. It is envisaged that the presence of the one or more layers of anti-degradation material comprising a plurality boron nitride structures may ensure that the perovskite solar cells remain protected from UV-induced degradation while maintaining their structural integrity against environmental factors such as moisture.

In such some embodiments, the layer of anti-degradation material comprising a plurality of boron nitride structures may comprise a surface coating material. In some embodiments of the invention, the surface coating material may comprise a paint, varnish or the like comprising a plurality of boron nitride structures. The paint may be applied to an outer surface of the perovskite solar cells using techniques including spray (air atomized, airless, electrostatic, high volume-low pressure) brushing, and dipping. The paint may include one or more further components. In these embodiments, the one or more further components may comprise polymers (such as, but not limited to, nitrocellulose, tosylamide-formaldehyde resin or acrylate copolymer), plasticisers (such as, but not limited to diethylphthalate, dibutylphthalate or camphor), pigments (such as, but not limited to chromium oxide greens, chromium hydroxide, ferric ferrocyanide, stannic oxide, titanium dioxide, iron oxide, carmine, ultramarine, manganese violet, mica, bismuth oxychloride, natural pearls or aluminum powder), thickeners (such as, but not limited to, stearalkonium hectorite) and/or UV-stabilisers (such as, but not limited to, benzophenone-1).

The surface coating material may comprise any suitable weight percent boron nitride structures. For instance, the surface coating material may comprise between about 0.05 wt % and about 60 wt % boron nitride structures. More preferably, the surface coating material may comprise between about 0.1 wt % and about 55 wt % boron nitride structures. Still more preferably, the surface coating material may comprise between about 0.5 wt % and about 50 wt % boron nitride structures. Yet more preferably, the surface coating material may comprise between about 0.5 wt % and about 30 wt % boron nitride structures. Even more preferably, the surface coating material may comprise between about 0.5 wt % and about 20 wt % boron nitride structures. Still more preferably the surface coating material may comprise between about 0.5 wt % and about 10 wt % boron nitride structures.

Preferably, the surface coating material comprises a settable, curable or hardenable material. In a preferred embodiment of the invention, the boron nitride structures may be substantially homogenously distributed in the surface coating material once set or hardened.

In other embodiments of the invention, the layer of anti-degradation material comprising a plurality of boron nitride structures may be in the form of a composite material. In this embodiment of the invention, the layer of anti-degradation material may comprise a matrix material impregnated with a plurality of boron nitride structures. The matrix material may be of any suitable form, and may comprise a polymer, a metal and/or a ceramic matrix material.

Any suitable polymer may be used. For instance, the polymer may be polyethylene, polypropylene, polystyrene, polyvinyl chloride, polyether sulphones, acrylonitrile butadiene styrene, polyether polyols, polyester polyols, polyacetal or polyoxymethylene (acetal, POM), polycarbonates, elastomers, thermoplastic elastomers, thermoplastic polyester, thermoplastic polyurethane, polyketones (such as but not limited to polyaryletherketone (PAEK), polyetheretherketone (PEEK), polyetherketoneketone (PEKK) or the like), acrylate polymers, poly(methyl methacrylate) (PMMA), polyphenylene sulfide (PPS), polyamides, polyphthalamide (PPA, performance Nylon), fluoropolymers (such as, but not limited to, polytetrafluoroethylene (PTFE), fluorinated ethylene propylene (FEP), polyvinylidene fluoride or polyvinylidene difluoride (PVDF), polychlorotrifluoroethylene (PCTFE), perfluoroalkoxy alkane (PFA), or the like), high density polyethylene (HDPE), ultra-high molecular weight polyethylene (UHMWPE), epoxy resins, phenolic resins, and the like, their monomers thereof, or any suitable combination thereof. In a preferred embodiment of the invention, the polymer may be a thermosetting polymer.

In some embodiments, the polymer may be an epoxy resin. Any suitable type of epoxy resin may be used, such as a bisphenol epoxy resins, an aliphatic epoxy resins, a novolac epoxy resin, a halogenated epoxy resin, an epoxy resin diluent, and/or a glycidylamine epoxy resin.

In some embodiments, the matrix material may comprise two or more polymers. The two or more polymers may be the same type of polymer or may be of different types.

The matrix material may comprise any suitable portion of the composite material. For instance, in some embodiments of the invention, the matrix material may comprise between about 25 wt % and 99.95 wt % of the composite material. More preferably, the matrix material may comprise between about 45 wt % and 99.9 wt % of the composite material. Most preferably, the matrix material may comprise between about 90 wt % and about 99.5 wt % of the composite material.

In other embodiments of the invention, the one or more layers of anti-degradation material may consist predominantly of boron nitride structures. In these embodiments, the one or more layers of anti-degradation material may comprise substantially entirely of boron nitride structures. Alternatively, a relatively small quantity of other materials may be added to the one or more layers of anti-degradation material. Such other materials may include a binder, settable or curable material, hardener, pigment or similar material.

In these embodiments, it is envisaged that one or more layers of anti-degradation material may be applied to the one or more perovskite solar cells using a deposition technique, such as a physical vapor deposition technique. Any suitable physical vapor deposition technique may be used, such as, but not limited to, cathodic arc deposition, electron-beam physical vapor deposition, evaporative deposition, close-space sublimation, ion plating, pulsed laser deposition, thermal laser epitaxy, sputter deposition, pulsed electron deposition or a combination thereof. In other embodiments, the deposition technique may comprise a chemical vapor deposition technique, hybrid physical-chemical vapor deposition technique, thin-film deposition technique and/or an ion beam assisted deposition technique.

In embodiments of the invention in which a deposition technique is used, the one or

more layers of anti-degradation material may comprise between about 50 wt % and about 100 wt % boron nitride structures. More preferably, the composite material may comprise between about 55 wt % and about 99.9 wt % boron nitride structures. Still more preferably, the composite material may comprise between about 60 wt % and about 99.9 wt % boron nitride structures. Yet more preferably, the composite material may comprise between about 65 wt % and about 99.9 wt % boron nitride structures. Even more preferably, the composite material may comprise between about 70 wt % and about 99.9 wt % boron nitride structures. Still more preferably the composite material may comprise between about 75 wt % and about 99.9 wt % boron nitride structures.

It is envisaged that the one or more layers of anti-degradation material may also provide improved mechanical strength, impact resistance and fire resistance.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a protective device according to an embodiment of the present invention.

FIG. 2 illustrates a fire protection device according to an embodiment of the present invention.

FIG. 3 illustrates a protective device according to an embodiment of the present invention in which the protected item is a solar panel.

FIG. 4 illustrates a protective device according to an embodiment of the present invention in which the enhanced item is watercraft, namely a surfboard.

FIG. 5 illustrates a protective device according to an embodiment of the present invention in which the protected item is a house.

FIGS. 6 to 9 illustrate protective devices according to embodiments of the present invention.

FIG. 10 illustrates a photovoltaic system including a perovskite solar cell according to an embodiment of the present invention.

FIG. 11 illustrates a wear part according to an embodiment of the present invention in the form of liners for a thickener or clarifier.

FIGS. 12 and 13 illustrates wear parts according to an embodiment of the present invention in the form of liners for pipes.

FIG. 14 illustrates wear parts according to an embodiment of the present invention in the form of liners for a hydrocyclone.

FIG. 15 illustrates a wear part according to an embodiment of the present invention in the form of a liner for a flotation cell.

### DETAILED DESCRIPTION

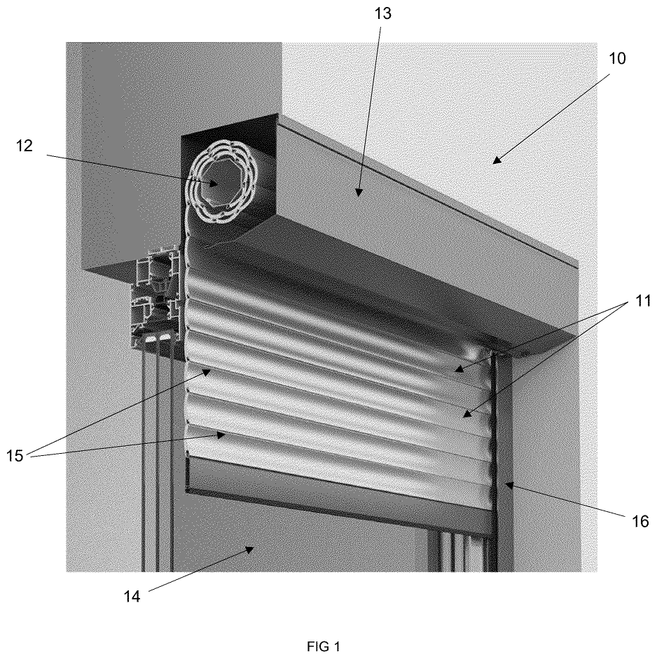

FIG. 1 illustrates a protective device 10 according to an embodiment of the present invention. The protective device 10 comprises a plurality of panel members 11 moveable between a storage condition and a use condition. In the embodiment of the invention shown in FIG. 1, the protective device 10 is in transition between the storage condition and the use condition. A portion of the panel members 11 are still in the storage condition wound about a reel 12. The reel 12 is housed within a housing 13 to reduce or eliminate the chances of the panel members 11 from being damaged when in the storage condition and/or to reduce or eliminate access to the panel members 11 by dirt, debris or animals, which may adversely affect the ability of the panel members 11 to move between the storage condition and the use condition.

The reel 12 is associated with a motor (not shown) wherein actuation of the motor actuates movement of the panel members 11 between the storage condition and the use condition.

In FIG. 1, some of the panel members 11 have moved into the use condition in which the panel members 11 overlie a window 14. It is envisaged that, when all panel members 11 have moved into the use condition, the panel members 11 will entirely overlie the window 14.

As can be seen in FIG. 1, the panel members 11 are elongate members that extend substantially horizontally in use. The panel members 11 are connected to one another along adjacent lateral edges 15 thereof. Preferably, no gaps exist between adjacent panel members 11, thereby preventing fire from reaching the window 14 through the panel members 11.

The protective device 10 further comprises a guide member 16 that extends substantially vertically adjacent a vertical edge of the window 14. It is envisaged that an end region of the panel members 11 may be received in the guide member 16. The guide member 16 may function to ensure that the panel members 11 move smoothly between the storage condition and the use condition. In addition, the guide member 16 may act to reduce or eliminate the possibility of fire reaching the window around opposed ends of the panel members 11.

The panel members 11 illustrated in FIG. 1 comprise one or more layers of fire-resistant material. It is envisaged that at least one of the one or more layers of fire-resistant material comprises a plurality of boron nitride structures. The boron nitride structures comprise one or more forms of crystalline boron nitride structures, such as nanotubes, boron nitride ribbon, boron nitride wire, boron nitride sheets, boron nitride nanosheets, boron nitride nano wire, boron nitride nano ribbon, or any combination thereof. In the embodiment of the invention shown in FIG. 1, however, the boron nitride structures comprise boron nitride sheets.

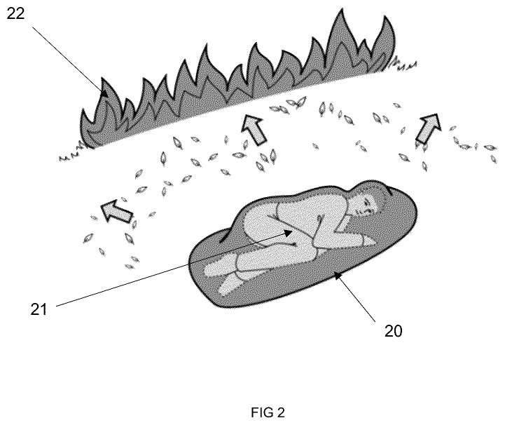

FIG. 2 illustrates a fire protection device 20 according to an embodiment of the present invention. The fire protection device 20 is in the form of a flexible sheet member comprising one or more layers of sheet material. At least one of the layers of sheet material includes a plurality of boron nitride structures. The boron nitride structures may comprise one or more forms of crystalline boron nitride structures, such as nanotubes, boron nitride ribbon, boron nitride wire, boron nitride sheets, boron nitride nanosheets, boron nitride nano wire, boron nitride nano ribbon, or any combination thereof. In the embodiment of the invention shown in FIG. 2, however, the boron nitride structures comprise boron nitride sheets.

The fire protection device 20 comprises a plurality of layers. In addition to the layer including the boron nitride structures, the fire protection device 20 includes layers of fire-resistant, fire retardant and/or heat resistant materials. The layers of fire-resistant, fire retardant and/or heat resistant materials are fabricated from polybenzimidazole, aramid, flame retardant cotton, coated nylon, carbon foam (CFOAM), melamine, modacrylic or the like, or a combination thereof.

The fire protection device 20 is provided in the form of a sheath that configured to be placed about a body of a user 21 if the user 21 is caught in the open near a bushfire 22. The user 21 covers their entire body, and the fire retardant, fire-resistant and/or heat resistant properties of the protection device 20 will protect the user 21 from both heat and flames as the bushfire passes over the user 21.

FIG. 3 illustrates a protective device 33 according to an embodiment of the present invention. The protective device 33 comprises a plurality of panel members 32 fastened above a glass surface, namely a solar panel 30a. In this representation of the invention, the panel members 32 comprise a composite material including a plurality of boron nitride structures, the boron nitride structures comprising one or more forms of crystalline boron nitride structures. The panel members 32 are at least semi-permeable to airflow, such as in the form of a lattice, mesh, or clear film.

The solar panel 30 in the unprotected configuration 31 is substantially exposed to harsh conditions and, in the event of high wind conditions, is vulnerable to impact damage from debris. The solar panel 30a in the protected configuration in the right-hand side of FIG. 3 is provided with the protective device 33 comprising a plurality of sheet panel members 32 spaced apart from the solar panel 30a by spacers 36. The spacers 36 provide a gap or cavity 38 between the solar panel 30a and the panel members 32 for maintenance and cleaning of the solar panel 30a.

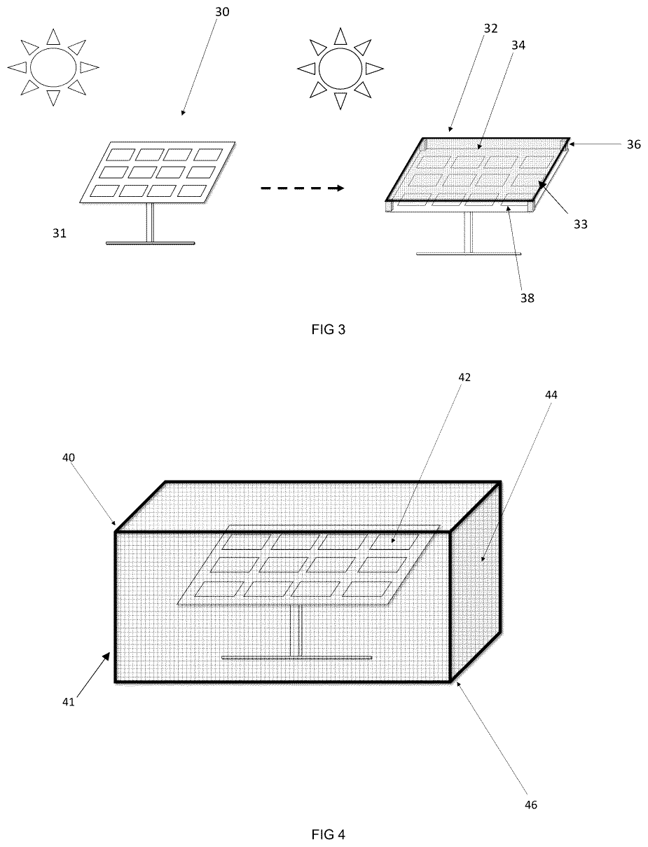

FIG. 4 illustrates a protective device 41 according to an embodiment of the present invention. In this Figure, the solar panel 42 is covered by the protective device 41 which comprises a plurality of panel members 44 in a housing arrangement 40. The panel members 44 are at least partially fabricated from a composite material including a plurality of boron nitride structures, the boron nitride structures comprising one or more forms of crystalline boron nitride structures.

The housing 40 comprises a plurality of sheet panel members 44 in which the sheet panel members 44 are at least semi-permeable to airflow, such as in the form of a lattice, mesh, or clear film. The sheet panel members 44 comprises a composite material that provides increased strength and lowered weight for easy removal and application. The housing 40 is structured using a frame 46 comprising a plurality of frame members.

FIG. 5 illustrates a watercraft 59 with protective properties according to an embodiment of the present invention. The watercraft depicted in the embodiment of the invention shown is a surfboard 59. The surfboard 59 is at least partially composed of a composite material including a plurality of boron nitride structures, the boron nitride structures comprising one or more forms of crystalline boron nitride structures. In the embodiment of the invention shown, the surfboard 59 includes a protective outer coating or layer 56 that comprises a composite material including a plurality of boron nitride structures, the boron nitride structures comprising one or more forms of crystalline boron nitride structures that provides increased strength and hydrophobicity. The surfboard 59 includes an inner core 54 comprising of a composite material including a plurality of boron nitride structures, the boron nitride structures comprising one or more forms of crystalline boron nitride structures that provides increased strength with a decreased weight. In the embodiment of the invention shown in FIG. 5 the surfboard 59 contains a flexible spine 58 comprising a composite material including a plurality of boron nitride structures, the boron nitride structures comprising one or more forms of crystalline boron nitride structures that provides increased flexibility and structural integrity to improve reproducibility and performance. The surfboard 59 will have improved performance and durability.

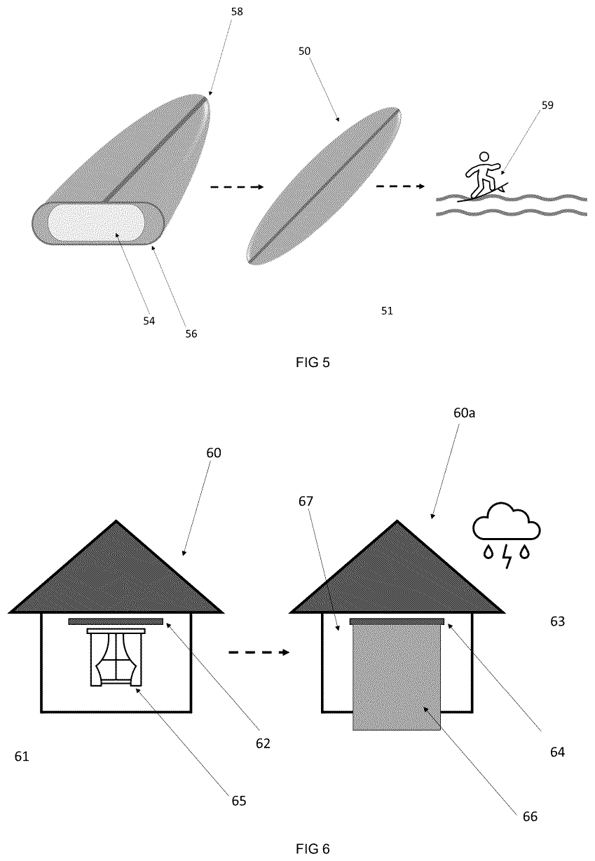

FIG. 6 illustrates a protective device 62 according to an embodiment of the present invention. The protective device 62 comprises a plurality of panel members 66 moveable between a storage condition 61 and a use condition 63. The panel members 66 are at least partially fabricated from a composite material including a plurality of boron nitride structures, the boron nitride structures comprising one or more forms of crystalline boron nitride structures. In the embodiment of the invention shown in FIG. 6, the protective device 62 is shown in the storage condition 61 and the use condition 63. In the embodiment of the invention shown in FIG. 6, the protective device 62 substantially covers a window 65 of a house 67 to prevent damage from harsh conditions (such as high wind conditions experienced in a storm, cyclone or the like). In the use condition 63, the protective device 62 provides the panel member 66 is extended so as to overlie the window 65, thereby protecting it from impact damage caused by debris. The protective device 62 is attached to the house 67 so that the protective device 62 can be moved from the storage condition 61 to the use condition 63. However, the protective device 62, when in the use condition 63, is spaced apart from the wall of the house 67. The protective device 62 may comprise of any number of portions containing the composite material.

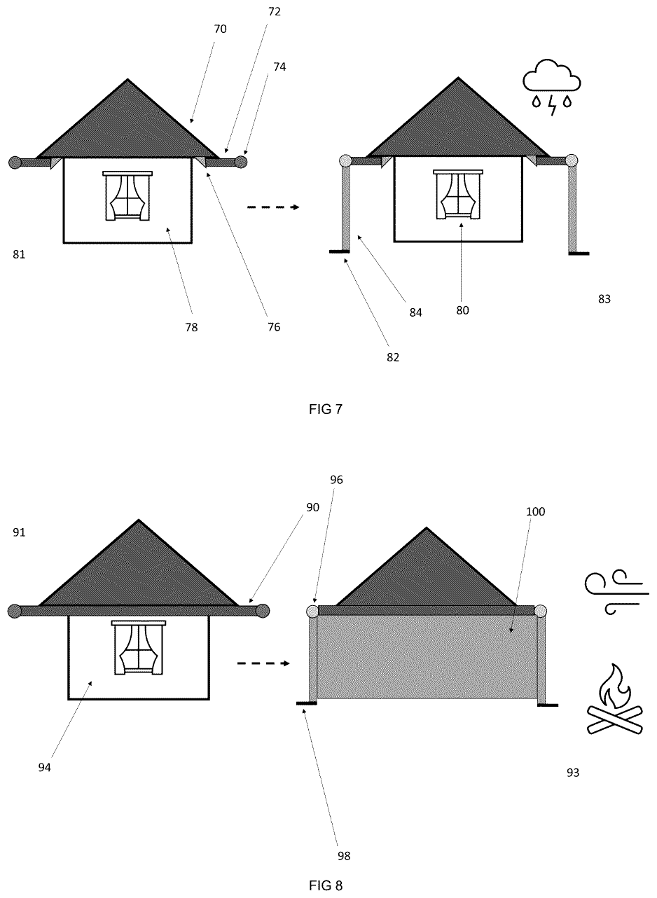

FIG. 7 illustrates a protective device 72 according to an embodiment of the present invention. The protective device 72 comprises a plurality of panel members 84 at least partially fabricated from a composite material including a plurality of boron nitride structures, the boron nitride structures comprising one or more forms of crystalline boron nitride structures and moveable between a storage condition 81 and a use condition 83. In the embodiment of the invention shown in FIG. 7, the protective device 72 is shown in the storage condition 81 and the use condition 83. In the use condition 83 the protective device 72 substantially covers at least a portion of a house 78 to prevent damage from harsh conditions (such as high wind conditions experienced in a storm, cyclone or the like). In the use condition 83, the protective device 72 provides a panel member 84 comprising the composite material that provides increased strength, fire resistance, water resistance and wind protection. The protective device 72 is attached to the house 76 such that, in the use condition 83, the protective device 72 is spaced apart from a wall of the house 78. The protective device 72 may comprise any number of portions containing the composite material. The protective device 72 shown in the embodiment of the invention in FIG. 7 contains a locking mechanism 82 to fasten the protective device 72 in the use condition 83.

FIG. 8 illustrates a protective device 90 according to an embodiment of the present invention. The protective device 90 comprises a plurality of panel members 100 at least partially fabricated from a composite material including a plurality of boron nitride structures, the boron nitride structures comprising one or more forms of crystalline boron nitride structures and moveable between a storage condition 91 and a use condition 93. In the embodiment of the invention shown in FIG. 8, the protective device 90 is shown in the storage condition 91 and the use condition 93. In the embodiment of the invention shown in FIG. 8, the protective device 90 substantially covers at least a portion of a house 94 to prevent damage from harsh conditions (such as high wind conditions experienced in a storm, cyclone or the like) and fire. In the use condition 93, the protective device 90 provides a panel member 100 comprising the composite material that provides increased strength, fire resistance, water resistance and wind protection. The protective device 90 is attached to the house 94 so that, in the use condition 93, the protective device 90 is spaced apart from a wall of the house 94. The protective device 90 may comprise of any number of portions containing the composite material. The protective device 90 shown in the embodiment of the invention in FIG. 8 contains a locking mechanism 98 to fasten the protective device 90 to a support surface (such as the ground) in the use condition 93. The protective device 90 may be positioned on the house 94 to protect the entire house 94 from fire.

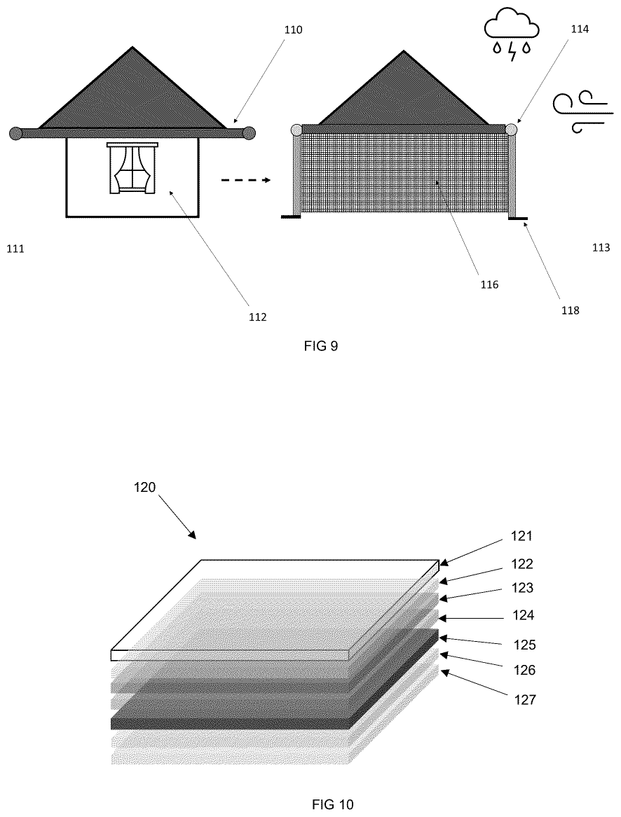

FIG. 9 illustrates a protective device 110 according to an embodiment of the present invention. The protective device 110 comprises a plurality of panel members 116 at least partially fabricated from a composite material including a plurality of boron nitride structures, the boron nitride structures comprising one or more forms of crystalline boron nitride structures and moveable between a storage condition 111 and a use condition 113. The plurality of panel members 116 are at least semi-permeable such as in the form of a lattice, mesh, or clear sheet configuration. The plurality of panel members 116 provide protection to the house 112 in the form of improved impact resistance (such as in high wind conditions) whilst still permitting air flow to house 112. In the embodiment of the invention shown in FIG. 9, the protective device 110 is shown in the storage condition 111 and the use condition 113. In the embodiment of the invention shown in FIG. 9, the protective device 110 substantially covers at least a portion of a house 112 to prevent damage from harsh conditions (such as storms, cyclones or the like). In the use condition 113, the protective device 110 provides a panel member 116 comprising the composite material that provides increased strength, fire resistance, water resistance and wind protection. The protective device 110 is attached to the house 112 so that the protective device 110, in the use condition, the protective device 116 is spaced apart from a wall of the house 112 113. The protective device 110 may comprise of any number of portions containing the composite material. The protective device 110 shown in the embodiment of the invention in FIG. 9 contains a locking mechanism 118 to fasten the protective device 110 to a support (such as a ground surface) in the use condition 113. The protective device 110 may be positioned on the house 112 to protect the entire house 112 from harsh conditions.

FIG. 10 illustrates a photovoltaic system including a perovskite solar cell 120 according to an embodiment of the present invention. The perovskite solar cell 120 is a thin-film device built with layers of materials, either printed or coated from liquid inks or vacuum-deposited. The layers of materials include a glass layer 122, a transparent electrode layer 123, an electron transporting layer 124, a perovskite layer 125, a hole transporting layer 126 and an electrode layer 127. In particular, a layer of anti-degradation material 121 comprising a plurality of boron nitride structures is provided to effectively block UV radiation. The layer of anti-degradation material 121 comprises a protective layer of the perovskite solar cell 120, thereby preventing water intrusion into the lower layers 122-127. The layer of anti-degradation material 121 comprises a surface coating material which comprise boron nitride structures. The boron nitride structures are substantially homogenously distributed in the surface coating material once set or hardened. It is envisaged that the layer of anti-degradation material 121 also provides improved mechanical strength, impact resistance and fire resistance.

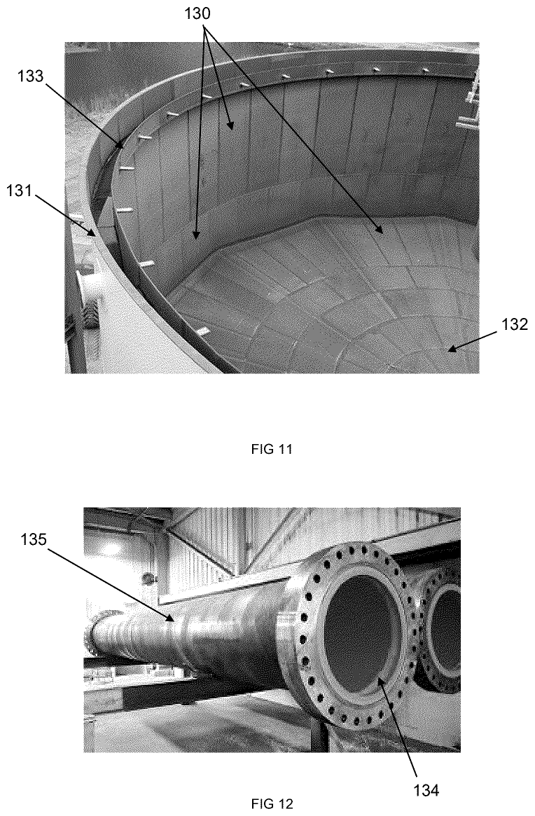

FIG. 11 illustrates a wear part according to an embodiment of the present invention in the form of liners 130 for a thickener or clarifier 131. The liners 130 are in the form of sheets or plates that are used to line the base 132 and an inner surface of a wall 133 of the thickener or clarifier 131.

In FIG. 11, the liners 130 comprise a plurality of boron nitride structures dispersed within a polymer matrix, such as polyurethane or rubber, the boron nitride structures comprising one or more forms of crystalline boron nitride structures. More specifically, the liners 130 comprise between about 0.5 wt % and about 20 wt % boron nitride nanotubes and boron nitride nanoplates dispersed within a polyurethane matrix. The boron nitride nanotubes and boron nitride nanoplates are dispersed substantially homogenously throughout the polyurethane matrix.

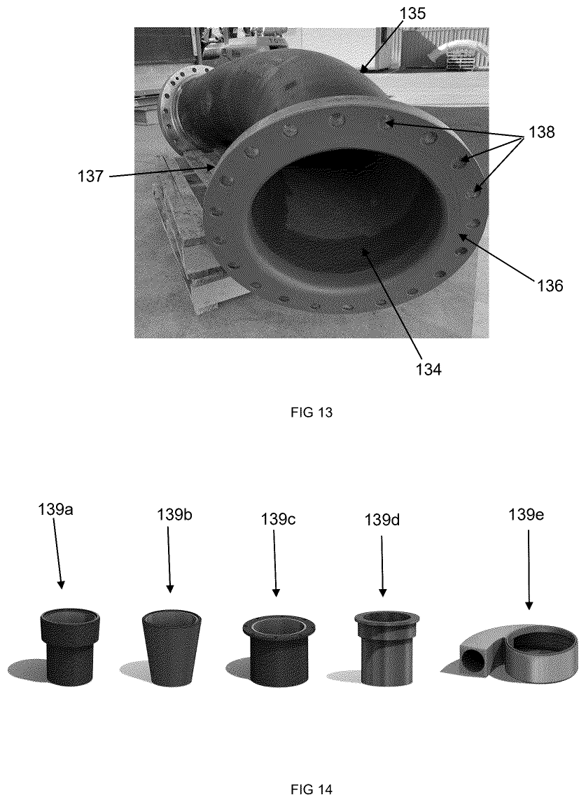

FIGS. 12 and 13 illustrates wear parts according to an embodiment of the present invention in the form of liners 134 for pipes 135. The liners 134 are in the form of tubes that are adhered to an inner surface of the pipes 135. The liners 134 may be formed as tubes, or may be formed in sheets and rolled into a tubular shape.

In FIGS. 12 and 13, the liners 134 comprise a plurality of boron nitride structures dispersed within a polymer matrix, such as polyurethane or rubber, the boron nitride structures comprising one or more forms of crystalline boron nitride structures. More specifically, the liners 134 comprise between about 0.5 wt % and about 20 wt % boron nitride nanotubes and boron nitride nanoplates dispersed within a polyurethane matrix. The boron nitride nanotubes and boron nitride nanoplates are dispersed substantially homogenously throughout the polyurethane matrix.

In FIG. 12, the liner 134 lines the inner surface of the pipe 135. In FIG. 13, however, the liner 135 includes a flange portion 136 that overlies the flange 137 of the pipe 135. The flange portion 136 includes a plurality of apertures 138 configured to receive fasteners therethrough when adjacent pipes 135 are connected to one another. Thus, in FIG. 13, the liner 135 also acts as a gasket or seal between adjacent pipe sections.

FIG. 14 illustrates wear parts according to an embodiment of the present invention in the form of liners 139a, 139b, 139c, 139d, 139e for a hydrocyclone (not illustrated). The liners 139a, 139b, 139c, 139d, 139e comprise a plurality of boron nitride structures dispersed within a polymer matrix, such as polyurethane or rubber, the boron nitride structures comprising one or more forms of crystalline boron nitride structures. More specifically, the liners 134 comprise between about 0.5 wt % and about 20 wt % boron nitride nanotubes and boron nitride nanoplates dispersed within a rubber matrix. The boron nitride nanotubes and boron nitride nanoplates are dispersed substantially homogenously throughout the rubber matrix.

In FIG. 14, the liners 139a, 139b, 139c, 139d, 139e are configured for use in different portions of the hydrocyclone (not shown). For instance, liner 139a is configured to line the apex of the hydrocyclone, liner 139b is configured to line the cone of the hydrocyclone, liner 139c is configured to line the spigot of the hydrocyclone, liner 139d is configured to line the vortex finder of the hydrocyclone, and liner 139e is configured to line the feed inlet/scroll of the hydrocyclone.

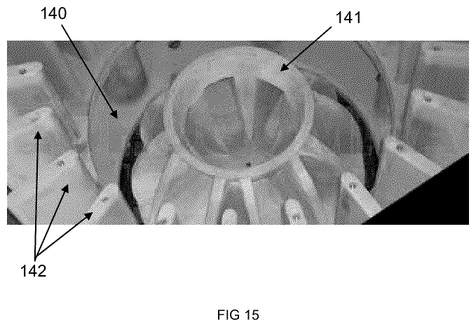

FIG. 15 illustrates a wear part according to an embodiment of the present invention in the form of a liner 140 for a flotation cell. The liner 140 comprises a plurality of boron nitride structures dispersed within a polymer matrix, such as polyurethane or rubber, the boron nitride structures comprising one or more forms of crystalline boron nitride structures. More specifically, the liner 140 comprises between about 0.5 wt % and about 20 wt % boron nitride nanotubes and boron nitride nanoplates dispersed within a polyurethane matrix. The boron nitride nanotubes and boron nitride nanoplates are dispersed substantially homogenously throughout the polyurethane matrix.

In the embodiment of the invention illustrated in FIG. 15, the liner 140 not only lines an inner surface of the flotation cell (not shown) but also includes structures that assist with creating conditions conducive to mixing and the recovery of valuable particles in the flotation process. For instance, the liner 140 includes a stator 141 configured to receive an impeller (not shown) therein, and a plurality of baffles 142 configured to enhance turbulence and mixing within the flotation cell (not shown).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A protection device comprising one or more panel members moveable between a storage condition and a use condition, the one or more panel members being configured to substantially overlie a window or door in the use condition, and wherein the one or more panel members comprise one or more layers of fire-resistant material, and wherein at least one of the one or more layers of fire-resistant material comprises a plurality of boron nitride structures, the boron nitride structures comprising one or more forms of crystalline boron nitride structures.

2. The protection device according to claim 1 wherein the one or more layers of fire-resistant material comprise a semi-permeable mesh, a lattice or a film.

3. The protection device according to claim 1 wherein the one or more forms of crystalline boron nitride structures comprise boron nitride nanotubes, boron nitride ribbon, boron nitride wire, boron nitride sheets, boron nitride nanosheets, boron nitride nano wire, boron nitride nano ribbon, or a combination thereof.

4. The protection device according to claim 1 wherein the crystalline boron nitride structures comprise two or more forms of crystalline boron nitride.

5. The protection device according to claim 1 comprising a plurality of panel members, wherein each of the plurality of panel members is configured to overlie a portion of the window or the door in the use condition.

6. The protection device according to claim 5 wherein the plurality of panel members are located in abutment with one another in the use condition.

7. The protection device according to claim 1 wherein an actuator is configured to move the one or more panel members between the storage condition and the use condition automatically in response to one or more environmental parameters.

8. The protection device according to claim 7 wherein the one or more environmental parameters include temperature, a change in temperature, barometric pressure, a change in barometric pressure, windspeed, a change in windspeed, air quality or a change in air quality.

9. The protection device according to claim 7 wherein the protection device comprises one or more sensors configured to measure the one or more environmental parameters.

10. The protection device according to claim 1 wherein the protection device comprises one or more guide members associated with the panel members, the one or more guide members configured to facilitate movement of the one or more panel members between the storage condition and the use condition.

11. The protection device according to claim 1 wherein the plurality of boron nitride structures comprises a surface coating material applied to at least one of the one or more layers of fire-resistant material.

12. The protection device according to claim 11 wherein the surface coating material comprises between about 0.5 wt % and about 20 wt % boron nitride structures.

13. The protection device according to claim 1 wherein at least one layer of the fire-resistant material comprises a matrix material impregnated with a plurality of boron nitride structures.

14. The protection device according to claim 13 wherein the matrix material is a polymer.

15. The protection device according to claim 1 wherein the presence of the boron nitride structures provides the one or more panel members with improved impact resistance properties.

16. A wear component comprising a plurality of boron nitride structures dispersed within a polymer matrix, the boron nitride structures comprising one or more forms of crystalline boron nitride structures.

17. The wear component according to claim 16, wherein the wear component comprises a liner for slurry handling equipment.

18. The wear according to claim 17 wherein the slurry handling equipment comprises pipes, pumps, hydrocyclones, tanks, thickeners, clarifiers and flotation cells.

19. The wear component according to claim 17 wherein the wear component is configured for attachment to an internal surface of the slurry handling equipment.

20. The wear component according to claim 16 wherein the wear component is flexible and/or elastic.
